(19) United States
(12) Patent Application Publication
(10) Pub. No.: US 2023/0367973 A1
(43) Pub. Date: Nov. 16, 2023

(54) SURFACING SUPPLEMENTAL INFORMATION

(71) Applicant: Abridge AI, Inc., Pittsburgh, PA (US)

(72) Inventors: Sandeep Konam, Pittsburgh, PA (US); Shivdev Rao, Pittsburgh, PA (US)

(21) Appl. No.: 18/196,069

(22) Filed: May 11, 2023

Related U.S. Application Data
(60) Provisional application No. 63/341,055, filed on May 12, 2022.

(51) Int. Cl. G06F 40/40; G06F 40/134; G06F 40/284

(52) U.S. Cl. CPC G06F 40/40; G06F 40/134; G06F 40/284

(57) ABSTRACT

Surfacing supplemental information may be provided by analyzing a transcript of a conversation, by a Natural Language Processing (NLP) system, to identify at least one candidate term in the conversation to provide supplemental information for to a reader of the transcript; in response to receiving, from the reader, a selection of the candidate term, formatting a query that includes the candidate term; in response to receiving a reply to the query: summarizing the reply into an explanation in a human-readable format; and outputting the explanation to the reader.

### CROSS-REFERENCES TO RELATED APPLICATIONS

The present disclosure claims priority to U.S. Provisional Patent Application No. 63/341,055 filed on May 12, 2022 with the title “SURFACING SUPPLEMENTAL INFORMATION”, which is incorporated herein by reference in its entirety.

### BACKGROUND

Many industries are driven by spoken conversations between parties. However, participants of these spoken conversations often mishear, forget, or misremember elements of these conversations, in addition to missing the importance of various elements within the conversation, which can lead to sub-optimal outcomes for the one or both parties. Additionally, some parties to these conversations may need to update charts, notes, or other records after having the conversations, which can be time consuming and subject to mishearing, forgetting, and misremembering the elements of the conversations, which can exacerbate any difficulties in recalling the correct details of the spoken conversation and taking appropriate follow-up actions.

The field of Natural Language Processing (NLP) is a branch of Artificial Intelligence (AI) directed to the understanding of freeform text and spoken words computing systems. Human speech, despite various grammatical rules, is generally unstructured, as there are myriad ways for a human to express one concept using natural language. Accordingly, processing human speech into a structured format usable by computing systems is a complex task for NLP systems to perform, and one that calls for great accuracy if the output for the NLP systems are to be trusted by human users for sensitive tasks.

### SUMMARY

The present disclosure is generally related to Artificial Intelligence (AI) and User Interface (UI) design and implementation useful for the analysis of transcripts of spoken natural language conversations.

The present disclosure provides methods and apparatuses (including systems and computer-readable storage media) to interact with various Machine Learning Models (MLM) trained to convert spoken utterances to written transcripts and summaries of those transcripts as part of a Natural Language Processing (NLP) system. Various parties to a conversation may have unequal levels of understanding of the terminology used in the conversation, or have different goals for interacting via the conversation. For example, an expert may converse with a novice to impart wisdom, while the novice may converse with the expert to learn about a subject or obtain answers to questions. However, the expert may use terms that the novice is unfamiliar with, and the novice may use various terms of art in the experts field incorrectly during the conversation, which may lead to confusion and misunderstanding between the parties when participating in the conversation or referring to a transcript of the conversation. In another example, two experts may discuss a topic, and although both parties understand the concepts discussed, when interacting with the transcript after the conversation has concluded, each of the experts may be interested in focusing on different concepts from the conversation for follow up or further review

The MLMs provided in the present disclosure may be employed to supplement the data identified from the conversation as being related to “candidate terms”. In some embodiments, the MLMs identify “candidate terms” from the terms used in the conversation that, based on the context of the conversation, may be a source for confusion between the parties, thereby allowing for the provision of supplemental detail which may be chosen based on the level of understanding of the party accessing the transcript. In some embodiments, the MLMs identify “candidate terms” from the terms used in the conversation that, based on the context of the conversation, may be of interest for further investigation by or on behalf of a certain party to the conversation.

Once candidate terms are identified, the MLMs then create human-readable explanations using the transcript or various external sources. These explanations can be pre-created and transmitted to the user along with the transcript to provide greater speed of access while engaged with the transcript, or may be generated on the fly when a user seeks to interact with a candidate term, thereby conserving computing resources by not generating explanations for terms that are not confusing to the human user. These explanations may be generated using the text of the transcript and one or more external supplemental data sources (which may be curated or selected by a party in the conversation) and are linked with related portions of the transcript to ensure understandability to the user, provide additional context, and allow easier interaction with and editing of the transcript. Accordingly, the present disclosure is generally directed to increasing and improving the functionality, efficiency, and usability of the underlying computing systems and MLMs via the various methods and apparatuses described herein via an improved UI.

One embodiment of the present disclosure is a method, comprising: analyzing a transcript of a conversation, by a Natural Language Processing (NLP) system, to identify at least one candidate term in the conversation to provide supplemental information for to a reader of the transcript; in response to receiving, from the reader, a selection of the candidate term, formatting a query that includes the candidate term; in response to receiving a reply to the query: summarizing the reply into an explanation in a human-readable format; and outputting the explanation to the reader.

In some embodiments, the NLP system identifies the candidate term from an action item generated from the transcript.

In some embodiments, the explanation includes a hyperlink to usage of the candidate term in the transcript associated with an utterance received from a party to the conversation.

In some embodiments, contents of the explanation are retrieved from a supplemental data source selected by a party in the conversation, different from the reader.

In some embodiments, the human-readable format is selected from a plurality of human-readable formats by the NLP system based on a supplementation level of the reader, and wherein the explanation uses vocabulary extracted from the transcript.

In some embodiments, the method further comprises: in response to receiving, from the reader, the selection of the candidate term, adding the selection to an aggregation report; and providing the aggregation report to a second party to the conversation, other than the reader.

In some embodiments, the explanation includes a hyperlink to an external source used by the NLP system to generate contents of the explanation.

One embodiment of the present disclosure is a method, comprising: transmitting, to a Natural Language Processing (NLP) system, audio from a conversation including utterances from a first party and a second party; receiving a transcript of the conversation from the NLP system and a candidate term identified from the transcript; outputting, to the first party, a display of the transcript and an indicator associated with the candidate term; in response to receiving a selection of the indicator, transmitting a request for additional information on the candidate term; receiving an explanation that summarizes data related to the candidate term retrieved from a supplemental data source, wherein the explanation is provided in a human-readable format; and outputting, to the first party, the explanation.

In some embodiments, the method further comprises: assessing a supplementation level of the first party using terminology extracted from utterances associated with the first party in a transcript of the conversation; selecting the human-readable format from a plurality of human-readable formats based on the supplementation level assessed for the first party; and requesting the explanation from the NLP system according to the human-readable format selected.

In some embodiments, the explanation is received from the NLP system with the transcript.

In some embodiments, the supplemental data source is selected by the second party.

In some embodiments, the method further comprises: identifying utterances from the second party related to the candidate term; and in response to receiving the selection of the indicator, outputting the utterances to the first party.

In some embodiments, the explanation is received with a transcript generated by the NLP system, the method further comprising: adjusting display of the transcript in a graphical user interface to show segments of the transcript that the NLP system extracted the candidate term from.

In some embodiments, the indicator is included in an action item assigned to the first party based on the transcript.

In some embodiments, the action item is created by the NLP system using terminology and context from a transcript of the conversation.

One embodiment of the present disclosure is a method, comprising: receiving, from a Natural Language Processing (NLP) system, a transcript of a conversation between at least a first party and a second party and a summary of the transcript that includes a candidate term to provide supplemental information for; generating a first display on a user interface that includes the transcript, the summary, and an indicator for the candidate term; in response to receiving a selection of the indicator from a reader: generating an informational window in the user interface that includes an explanation related to the candidate term; and adjusting display of the user interface to highlight a section of the transcript from which the NLP system identified the candidate term as part of an key point from the conversation, wherein the informational window is positioned with the section to maintain legibility of the section and the informational window.

In some embodiments the method further comprises: providing audio playback of the section to the reader.

In some embodiments, the reader is the first party and the summary is tuned to a supplementation level of the first party that is based on vocabulary extracted from the transcript.

In some embodiments, the key point is generated by the NLP system using terminology and context from the transcript.

In some embodiments, the method further comprises: populating the informational window with supplemental data from an external supplemental data source identified by the second party, different than the reader, that is under control of a third party, different from the second party and the reader.

### BRIEF DESCRIPTION OF THE DRAWINGS

The accompanying figures depict various elements of the one or more embodiments of the present disclosure, and are not considered limiting of the scope of the present disclosure.

In the Figures, some elements may be shown not to scale with other elements so as to more clearly show the details. Additionally, like reference numbers are used, where possible, to indicate like elements throughout the several Figures.

It is contemplated that elements and features of one embodiment may be beneficially incorporated in the other embodiments without further recitation or illustration. For example, as the Figures may show alternative views and time periods, various elements shown in a first Figure may be omitted from the illustration shown in a corresponding second Figure without disclaiming the inclusion of those elements in the embodiments illustrated or discussed in relation to the second Figure.

FIG. 1 illustrates an example environment in which a conversation is taking place, according to embodiments of the present disclosure.

FIG. 2 illustrates a computing environment, according to embodiments of the present disclosure.

FIG. 3 illustrates a candidate term identifier, according to embodiments of the present disclosure.

FIGS. 4A-4G illustrate interactions with a Graphical User Interface that displays a transcript and candidate terms identified from a conversation, according to embodiments of the present disclosure.

FIG. 5 is a flowchart of a method for identifying candidate terms for a reader from a conversation, according to embodiments of the present disclosure.

FIG. 6 is a flowchart of a method for providing supplemental information via a UI to a reader in conjunction with a transcript, according to embodiments of the present disclosure.

FIG. 7 is a flowchart of a method for providing supplemental information via a UI to a reader in conjunction with a transcript, according to embodiments of the present disclosure.

FIG. 8 is a flowchart of a method for managing a GUI to provide explanations of candidate terms in association with a transcript, according to embodiments of the present disclosure.

FIG. 9 illustrates physical components of a computing device, according to embodiments of the present disclosure.

### DETAILED DESCRIPTION

Because transcripts of spoken conversations are becoming increasingly important in a variety of fields, the accuracy of those transcripts and the interpreted elements extracted from those transcripts is also increasing in importance. Accordingly, accuracy in the transcript affects the accuracy in the later analyses, and greater accuracy in transcription and analysis improves the usefulness of the underlying systems used to generate the transcript and analyses thereof.

To create these transcripts and the analyses thereof, the present disclosure describes a Natural Language Processing (NLP) system. As used herein, NLP is the technical field for the interaction between computing devices and unstructured human language for the computing devices to be able to “understand” the contents of the conversation and react accordingly. An NLP system may be divided into a Speech Recognition (SR) system, that generates a transcript from a spoken conversation, and an analysis system, that extracts additional information from the written record. In various embodiments, the NLP system may use separate Machine Learning Models (MLMs) for each of the SR system and the analysis system, or may use one MLM to handle the SR tasks and the analysis tasks.

One element extracted from a transcript can be a word or phrase of several words (generally referred to herein as a “term”) that when encountered by a reader of the transcript, may result in the reader desiring further explanation. These terms may relate to elements of the conversation that may not be clear to or be understood by the reader or that the NLP system identifies as of further interest to the reader. However, as natural human conversations often include implicit assumptions of the knowledge of the participants, with the participants providing indications of their level of understanding, by their role, or via unspoken cues (e.g., facial expressions, body language) and tonal cues that indicate their level of understanding and interest in a concept, the transcript itself may be insufficient to identify whether a term is understood or of interest for further review. Accordingly, present NLP systems can have difficulties in identifying unclear terms or terms of interest, and can be intrusive and irritating to users when presenting explanatory content (e.g., over explaining).

The present disclosure therefore provides an NLP system that identifies candidate terms, which are suspected of being unclear or not understood by a reader or otherwise of further interest to the reader for a follow up explanation, that allows the reader to select which terms to provide additional explanations for, provides various levels of additional explanation based on the understanding and curiosity levels of the user, and that solicits feedback for the NLP system to identify or ignore certain terms in the future as candidate terms in different contexts. In various embodiments, the NLP system may manage the creation and provision of the explanations to readers via an explainer module, layer, or sub-system, or an external service may operate in conjunction with the NLP system to create and provide the explanations.

As the human users interact via the UI with a transcript and the candidate terms (and other extracted elements) identified from the conversation, the UI exposes some or all of the operations of the MLM to the users. By exposing the operations of the MLMs, the UI provides the users with the opportunity to provide edits and more-relevant feedback to the outputs of the MLMs. Accordingly, the UI gives the users greater control over retraining or updating MLMs for specific use cases. This greater level of control, in turn, provides greater confidence in the accuracy of the MLMs and NLP systems, and thus can expand the possibilities for using the data output by the MLMs and NLP systems or reduce the need for a human user to confirm the outputs of the MLMs and NLP systems. However, in scenarios where the MLMs and NLP systems are still monitored by a human user, or the human user otherwise interacts with or edits the outputs of the MLMs and NLP systems, the UI provides a faster and more convenient approach to perform those interactions and edits than previous UIs. Accordingly, the present disclosure is generally directed to increasing and improving the functionality, efficiency, and usability of the underlying computing systems and MLMs via the various methods and apparatuses described herein via an improved UI.

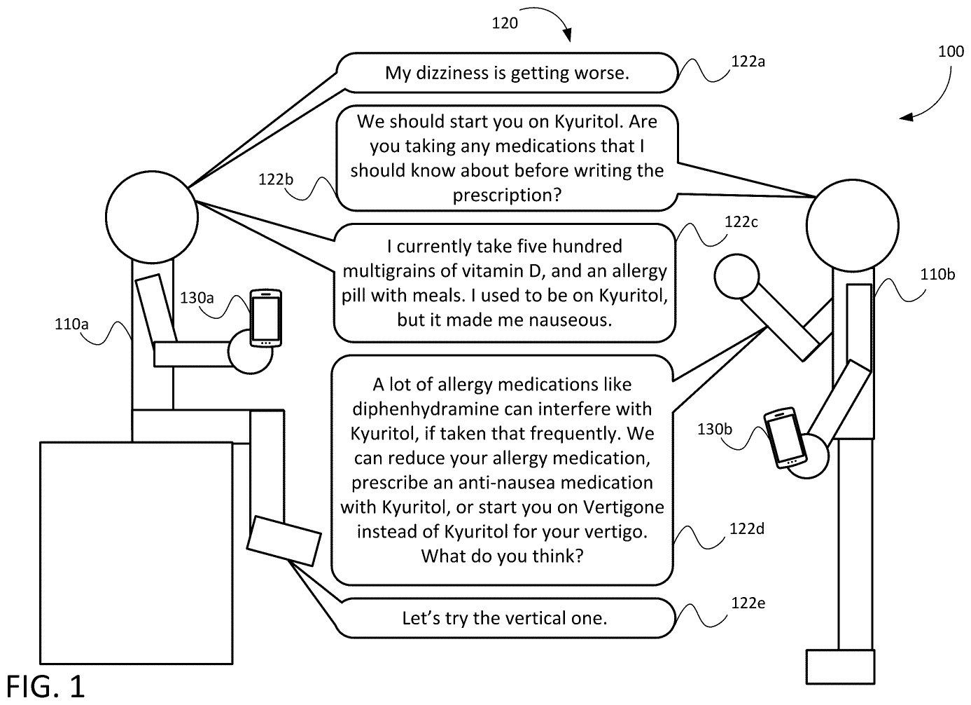

FIG. 1 illustrates an example environment 100 in which a conversation is taking place, according to embodiments of the present disclosure. As shown in FIG. 1, a first party 110a (generally or collectively, party 110) is holding a conversation 120 with a second party 110b. The conversation 120 is spoken aloud and includes several utterances 122a-e (generally or collectively, utterances 122) spoken by the first party 110a and by the second party 110b in relation to a healthcare visit. As shown in the example scenario, the first party 110a is a patient and the second party 110b is a caregiver (e.g., a doctor, nurse, nurse practitioner, physician's assistant, etc.). Although two parties 110 are shown in FIG. 1, in various embodiments, more than two parties 110 may contribute to the conversation 120 or may be present in the environment 100 and not contribute to the conversation 120 (e.g., by not providing utterances 122).

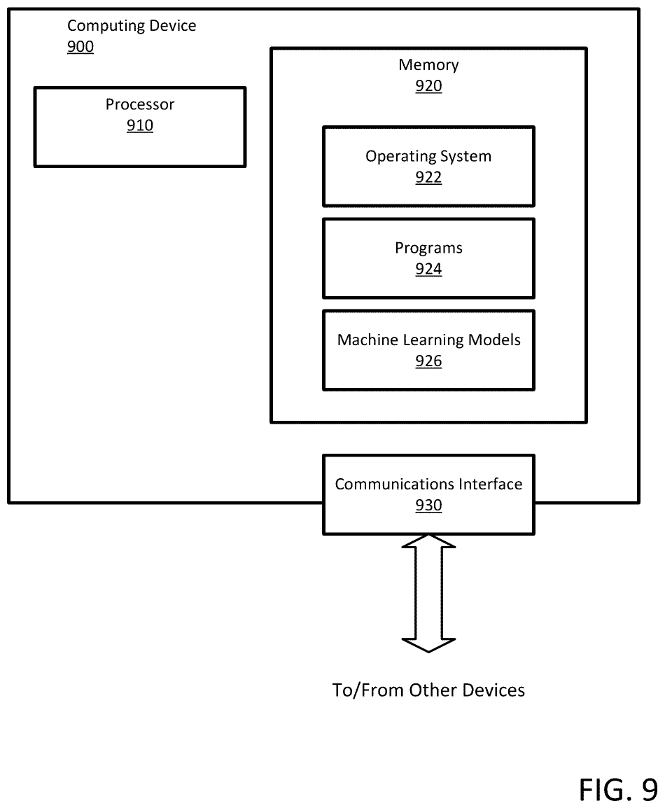

One or more recording devices 130a-b (generally or collectively, recording device 130) are included in the environment 100 to record the conversation 120. In various embodiments, the recording devices 130 may be any device (e.g., such as the computing device 900 described in relation to FIG. 9) that is capable of recording the audio of the conversation, which may include cellphones, dictation devices, laptops, tablets, personal assistant devices, or the like. In various embodiments, the recording devices 130 may transmit the conversation 120 for processing to a remote service (e.g., via a telephone or data network), locally store or cache the recording of the conversation 120 for later processing (locally or remotely), or combinations thereof. In various embodiments, the recording device 130 may pre-process the recording of the conversation 120 to remove or filter out environmental noise, compress the audio, remove undesired sections of the conversation (e.g., silences or user-indicated portions to remove), which may reduce data transmission loads or otherwise increase the speed of transmission of the conversation 120 over a network.

Although FIG. 1 shows two recording devices 130 in the environment 100, where each recording device 130 is associated with one party 110, the present disclosure contemplates other embodiments that may include more or fewer recording devices 130 with different associations to the various parties 110 in the environment 100. For example, a recording device 130 may be associated with the environment 100 (e.g., a recording device 130 for a given room) instead of a party 110, or may be associated with parties 110 who are not participating in the conversation 120, but are present in the environment 100. Additionally, although the environment 100 is shown as a room in which both parties 110 are co-located, in various embodiments, the environment 100 may be a virtual environment or two distant spaces that at linked via teleconference software, a telephone call, or other situation where the parties 110 are not co-located, but are linked technologically to hold the conversation 120.

Recording and transcribing conversations 120 related to healthcare, technology, academia, or various other esoteric topics can be particularly challenging for NLP systems due to the low number of example utterances 122 that include related terms, the inclusion of jargon and shorthand used in the particular domain, the similarities in phonetics of markedly different terms within the domain (e.g., lactase vs. lactose), similar terms having certain meanings inside of the domain that are different from or more specific than the meanings used outside of the domain, mispronunciation or misuse of domain terms by non-experts speaking to domain experts, and other challenges.

One such challenge is that different parties 110 to the conversation 120 may have different levels of experience in the use of the terms used in the conversation 120 or the pronunciation of those terms. For example, an experienced mechanic may refer to a component of an engine by part number, by a nickname, or the specific technical term, while an inexperienced mechanic (or the owner) may refer to the same component via a placeholder (e.g., “the part”), an incorrect term, or an unusual pronunciation (e.g., placing emphasis on the wrong syllable). In another example, a teacher may record a conversation with a student, where the teacher corrects the student's use of various terms or pronunciation, and the conversation 120 includes the misused terminologies, despite both the student and teacher attempting to refer to the same concept. Distinguishing which party 110 is “correct” and that both parties 110 are attempting to refer to the same concept within the domain despite using different wording or pronunciation, can therefore prove challenging for NLP systems.

As illustrated, the conversation 120 includes an exchange between a patient and a caregiver related to the medications that the patient should be prescribed to treat an underlying condition as one example of an esoteric conversation 120 occurring in a healthcare setting. FIG. 1 illustrates the conversation 120 using the intended contents of the utterances 122 from the perspectives of the speakers of those utterances 122, which may include errors made by the speaker. The examples given elsewhere in the present disclosure may build upon the example given in FIG. 1 to variously include misidentified versions of the contents or corrected versions of the contents.

For example, when an NLP system erroneously identifies spoken term A (e.g., the NLP system identified an utterance of be “taste taker”), a user or correction program, may correct the transcription to instead display term B (e.g., changing “taste taker” to “pacemaker” as intended in the utterance). In another example, when a party 110 intended to say term A, and was identified as saying term A, but the correct term is term B, the NLP system can substitutes term B for term A in the transcript.

What term is “correct” may vary based on the level of experience of the party, so that the NLP system may substitute synonymous terms as being more “correct” for the user's context. For example, when a doctor states correctly the chemical name for the allergy medication “diphenhydramine”, the NLP system can “correct” the transcript to read or include additional definitions to state “your allergy medication”. Similarly, various jargon or shorthand phrases may be removed for the more-accessible versions of those phrases in the transcript. Additionally or alternatively, if the party 110 is identified as attempting to say (and mispronouncing) a difficult to pronounce term, such as a chemical name for the allergy medication “diphenhydramine”, (e.g., as “DIFF-enhy-DRAY-MINE” rather than “di-FEN-hye-DRA-meen”), the NLP system can correct the transcript to remove any misidentified terms based on the mispronounced term and substitute in the correct difficult-to-pronounce term.

As intended by the participants of the example conversation 120, the first utterance 122a from the patient includes spoken contents of “my dizziness is getting worse”, to which the caregiver replies in the second utterance 122b “We should start you on Kyuritol. Are you taking any medications that I should know about before writing the prescription?”. The patient replies in the third utterance 122c that “I currently take five hundred multigrains of vitamin D, and an allergy pill with meals. I used to be on Kyuritol, but it made me nauseous.” The caregiver responds in the fourth utterance 122d with “a lot of allergy medications like diphenhydramine can interfere with Kyuritol, if taken that frequently. We can reduce your allergy medication, prescribe an anti-nausea medication with Kyuritol, or start you on Vertigone instead of Kyuritol for your vertigo. What do you think?”. The conversation 120 concludes with the fifth utterance 122e from the patient of “let's try the vertical one.”

Using the illustrated conversation 120 as an example, the patient provided several utterances 122 with misspoken terminology (e.g., “multigrains” instead of “milligrams”, “vertical” instead of “Vertigone” or “vertigo”) that the caregiver did not follow up on (e.g., no question requesting clarification was spoken), as the intended meaning of the utterances 122 was likely clear in context to the caregiver. However, the NLP system may accurately transcribe these misstatements, which can lead to confusion or misidentification of the features of the conversation 120 by a MLM or human user that later reviews the transcript. When later reviewing the transcript, the context may have to be reestablished before the intended meaning of the misspoken utterances can be made clear, thus causing human frustration or errors in analysis systems unless additional time to read and analyze the transcript is expended.

Additionally or alternatively, the inclusion of terms unfamiliar to a party 110 in the conversation 120, even if provided accurately in a later transcript, may lead to confusion or misidentification of the conversation 120 by a MLM or human user. For example, the caregiver mentioned “diphenhydramine”, which may be an unfamiliar term to the patient, despite referring to a popular antihistamine and allergy medication, and the caregiver uses the more scientific-sounding term “vertigo” to refer to condition indicated by the symptom of “dizziness” spoken by the patient, which may have been clear in context at the time of the conversation 120 or glossed over during the conversation 120, but are deserving of follow-up when reviewing the transcript.

The present disclosure therefore provides for UIs that allow users to be able to easily interact with the transcripts to expose various processes of the NLP systems and MLMs that produced and interacted with the conversation 120 and transcripts thereof. A user is thereby provided with an improved experience in examining the transcript and modifying the underlying NLP systems and MLMs to provide more accurate and better trusted analysis results in the future.

Although the present disclosure primarily uses the example conversation related to a healthcare visit shown in FIG. 1 as a basis for the examples discussed in the other Figures, the present disclosure may be used for the provision and manipulation of interactive data gleaned from transcripts of conversations related to various topics outside of the healthcare space or between different parties within the healthcare space. Accordingly, the environment 100 and conversation 120 shown and discussed in relation to FIG. 1 are provided as a non-limiting example; other conversations in other settings (e.g., equipment maintenance, education, law, agriculture, etc.) and between other persons (e.g., a first caregiver and a second caregiver, a guardian and a caregiver, a guardian and a patient, etc.) are contemplated by the present disclosure.

Additionally, although the example conversations and analyzed terms discussed herein are primarily provided in English, the present disclosure may be applied for transcribing a variety of languages with different vocabularies, grammatical rules, word-formation rules, and use of tone to convey complex semantic meanings and relationships between words.

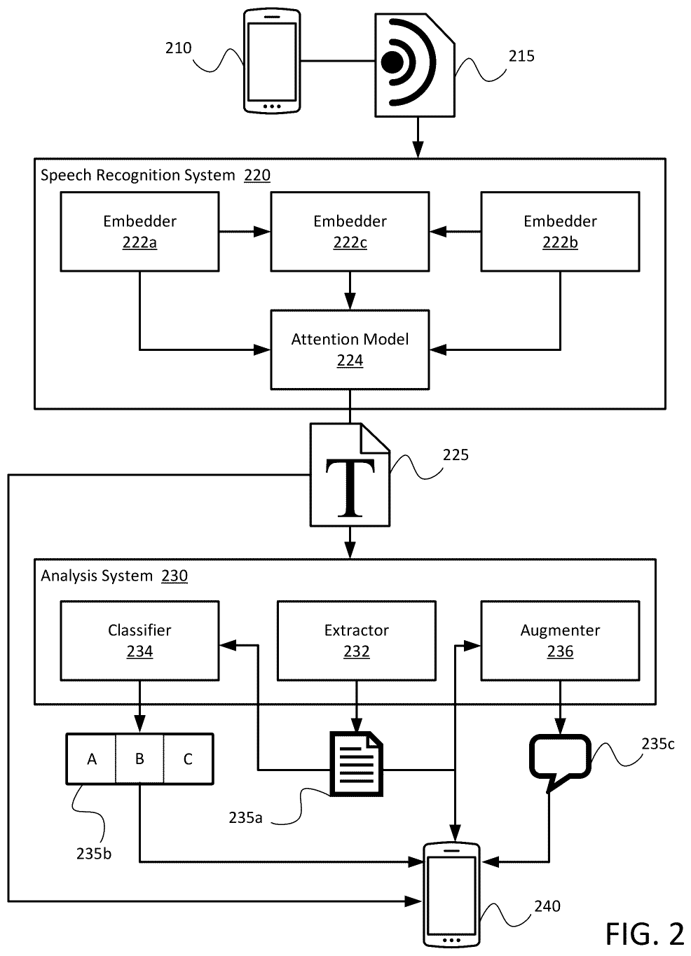

FIG. 2 illustrates a computing environment 200, according to embodiments of the present disclosure. The computing environment 200 may represent a distributed computing environment that includes multiple computers, such as the computing device 900 discussed in relation to FIG. 9, interacting to provide different elements of the computing environment 200 or may include a single computer that locally provides the different elements of the computing environment 200. Accordingly, some or all of the elements illustrated with a single reference number or object in FIG. 2 may include several instances of that element, and individual elements illustrated with one reference number or object may be performed partially or in parallel by multiple computing devices.

The computing environment 200 includes an audio provider 210, such as a recording device 130 described in relation to FIG. 1, that provides a recording 215 of a completed conversation or individual utterances of an ongoing conversation to a Speech Recognition (SR) system 220 to identify the various words and intents within the conversation. The SR system 220 provides a transcript 225 of the recording 215 to an analysis system 230 to identify and analyze various aspects of the conversation relevant to the participants. As used herein, the SR system 220 and the analysis system 230 may be jointly referred to as an NLP system.

As received, the recording 215 may include an audio file of the conversation, video data associated with the audio data (e.g., a video recording of the conversation vs. an audio-only recording), as well as various metadata related to the conversation, and may also include video data. For example, a user account associated with the audio provider 210 may serve to identify one or more of the participants in the conversation, or append metadata related to the participants. For example, when a recording 215 is received from an audio provider 210 associated with John Doe, the recording 215 may include metadata that John Doe is a participant in the conversation. The user of the audio provider 210 may also indicate that the conversation took place with Erika Mustermann, (e.g., to provide the identity of another speaker not associated with the audio provider 210), when the conversation took place, whether the conversation is complete or is ongoing, where the conversation took place, what the conversation concerns, or the like.

The SR system 220 receives the recording 215 and processes the recording 215 via various machine learning models to convert the spoken conversation into various words in textual form. The models may be domain specific (e.g., trained on a corpus of words for a particular technical field) or general purpose (e.g., trained on a corpus of words for general speech patterns). In various embodiments, the SR system 220 may use an Embedding from Language Models (ELMo) model or a Bidirectional Encoder Representation from Transformers (BERT) model or other machine learning models to convert the natural language spoken audio into a transcribed version of the audio. In various embodiments, the SR system 220 may use Transformer networks, a Connectionist Temporal Classification (CTC) phoneme based model, a Listen Attend and Spell (LAS) grapheme based model, or any of other models to convert the natural language spoken audio into a transcribed version of the audio. In some embodiments, the analysis system 230 may be a large language model (LLM).

Converting the spoken utterances to a written transcript not only matches the phonemes to corresponding characters and words, but also uses the syntactical and grammatical relationship between the words to identify a semantic intent of the utterance. The SR system 220 uses this identified semantic intent to select the most correct word in the context of the conversation. For example, the words “there”, “their”, and “they're” all sound identical in most English dialects and accents, but convey different semantic intents, and the SR system 220 selects one of the options for inclusion in the transcript for a given utterance. Accordingly, an attention model 224, is used to provide context of the various different candidate words among each other. The selected attention model 224 can use a Long Short Term Memory (LSTM) architecture to track relevancy of nearby words on the syntactical and grammatical relationships between words at a sentence level or across sentences (e.g., to identify a noun introduced in an earlier utterance related to a pronoun in a later utterance).

The SR system 220 can include one or more embedders 222a-c (generally or collectively embedder 222) to embed further annotations to the transcript 225, such as, for example by including: key term identifiers, timestamps, segment boundaries, speaker identifies, and the like. Each embedder 222 may be a trained MLM to identify various features in the audio recording 215 and/or transcript 225 that are used for further analysis by an attention model 224 or extraction by the analysis system 230.

For example, a first embedder 222a is trained to recognize key terms, and may be provided with a set of words, relations between words, or the like to analyze the transcript 225 for. Key terms may be defined to include various terms (and synonyms) of interest to the users. For example, in a medical domain, the names of various medications, therapies, regimens, syndromes, diseases, symptoms, etc., can be set as key terms. In a maintenance domain, the names of various mechanical or electrical components, assurance tests, completed systems, locational terms, procedures, etc., can be set as key terms. In another example, time based words may be identified as candidate key terms (e.g., Friday, tomorrow, last week). Once recognized in the text of the transcript, a key term embedder 222 may embed a metadata tag to identify the related word or set of words as a key term, which may include tagging pronouns associated with a noun with the same metadata tags as the associated noun.

A second embedder 222b can be used by the SR system 220 to recognize different participants in the conversation. In various embodiments, individual speakers may be distinguished by vocal patterns (e.g., a different fundamental frequency for each speaker's voice), loudness of the utterances (e.g., identifying different locations relative to a recording device), or the like.

In another example, a third embedder 222c is trained to recognize segments within a conversation. In various embodiments, the SR system 220 diarizes the conversation into portions that identify the speaker, and provides punctuation for the resulting sentences (e.g., commas at short pauses, periods at longer pauses, question marks at a longer pause preceded by rising intonation) based on the language being spoken. The third embedder 222c may then add metadata tags for who is speaking a given sentence (as determined by the second embedder 222b) and group one or more portions of the sentence together into segments based on one or more of a shared theme or shared speaker, question breaks in the conversation, time period (e.g., a segment may be between X and Y minutes long before being joined with another segment or broken into multiple segments), or the like.

When using a shared theme to generate segments, the SR system 220 may use some of the key terms identified by a key term embedder 222 via string matching. For each of the detected key terms identifying a theme, the segment identifying embedder 222 selects a set of nearby sentences to group together as a segment. For example, when a first sentence uses a noun, and a second sentence uses a pronoun for that noun, the two sentences may be grouped together as a sentence. In another example, when a first person provides a question, and a second person provides a responsive answer to that question, the question and the answer may be grouped together as a segment. In some embodiments, the SR system 220 may define a segment to include between X and Y sentences, where another key term for another segment (and the proximity to the second key term to the first) may define ab edge between adjacent segments.

Once the SR system 220 generates a transcript 225 of the identified words from the recording 215, the SR system 220 provides the transcript 225 to an analysis system 230 to generate various analysis outputs 235 from the conversation. In various embodiments, the operations of the SR system 220 are separately controlled from the operations of the analysis system 230, and the analysis system 230 may therefore operate on a transcript 225 of a written conversation or a human-generated transcript (e.g., omitting the SR system 220 from the NLP system or substituting a non-MLM system for the SR system 220). The SR system 220 may directly transmit the transcript 225 to the output device 240 (before or after the analysis system 230 has analyzed the transcript 225), or the analysis system 230 may transmit the transcript 225 to the output device 240 on behalf of the SR system 220 once analysis is complete.

The analysis system 230 may use an extractor 232 to generate readouts 235a of the key points to provide human-readable summaries of the interactions between the various identified key terms from the transcript. These summaries include the identified key terms (or related synonyms) and are formatted according to factors for sufficiency, minimality, and naturalness. Sufficiency defines a characteristic for a key point that, if given only the annotated span, a reader should be able to predict the correct classification label for the key point, which encourages longer key points that cover all distinguishing or background information needed to interpret the contents of a key point. Minimality defines a characteristic for a key point that identifies peripheral words which can be replaced with other words without changing the classification label for the key point, which discourages marking entire utterances as needed for the interpretation of a key point. Naturalness defines a characteristic for a key point that, if presented to a human reader should sound like a complete phrases in the language used (or as a meaningful word if the key point has only a single key term) to avoid dropping stop words from within phrases and reduce the cognitive load on the human who uses the NLP system's extraction output.

For example, when presented with a series of sentences from the transcript 225 related to how frequently a user should replace a battery in a device, and what type of battery to use, the extractor 232 may analyze several sentences or segments to identify relevant utterances spoken by more than one person to arrive at a summary. The readout 235a may recite “Replace battery; Every year; Use nine volt alkaline” to provide all or most of the relevant information in a human-readable format that was gathered from a much larger conversation.

A category classifier 234 included in the analysis system 230 may operate in conjunction with the extractor 232 to identify various categories 235b that the readouts 235a belong to. In various embodiments, the categories 235b include several different classifications for different users with different review goals for the same conversation. In various embodiments, the category classifier 234 determines the classification based on one or more context vectors developed via the attention model 224 of the SR system 220 to identify whether a given segment or portion of the conversation belongs to which category (including a null category) out of a plurality of potential categories that a user can select from the system to classify portions of the conversation into.

The analysis system 230 may include an augmenter 236 that operates in conjunction with the extractor 232 to develop supplemental content 235c to provide with the transcript 225. In various embodiments, the supplemental content 235c can include callouts of pseudo-key terms based on inferred or omitted details from a conversation, hyperlinks between key points and semantically relevant segments of the transcript, links to (or provides the content for) supplemental or definitional information to display with the transcript, calendar integration with extracted terms, or the like.

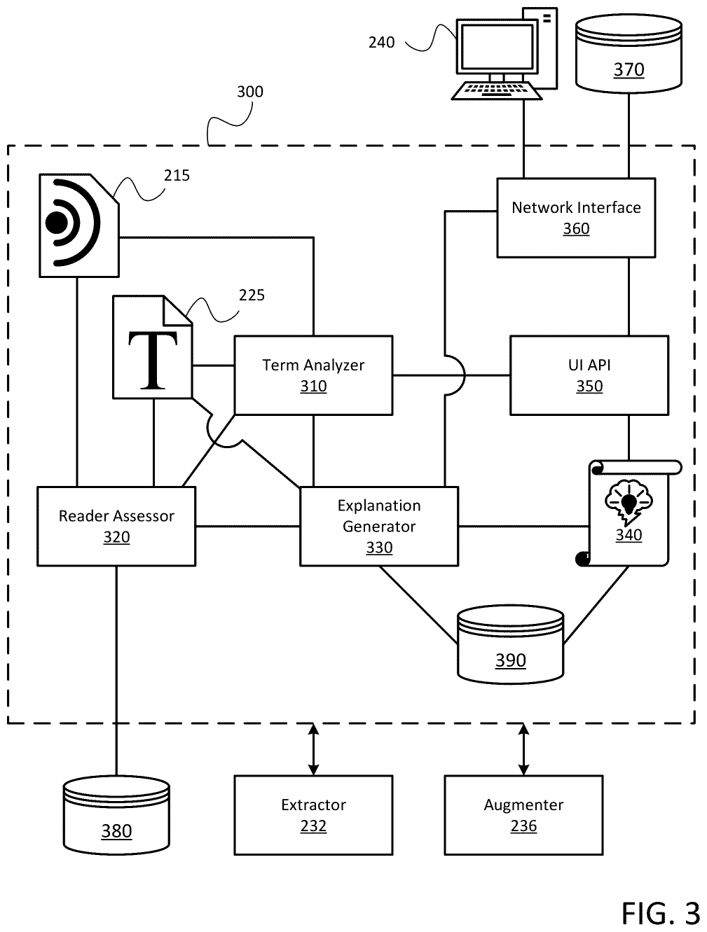

For example, when the extractor 232 identifies terms related to a planned follow up conversation (e.g., “I will call you back in thirty minutes”), the augmenter 236 can generate supplemental content 235c that includes a calendar invitation or reminder in a calendar application associated with one or more of the participants that a call is expected thirty minutes from when the conversation took place. Similarly, if the augmenter 236 identifies terms related to a planned follow up conversation that omits temporal information (e.g., “I will call you back”), the augmenter 236 can generate a pseudo-key term to treat the open-ended follow up as though an actual follow up time had been set (e.g., to follow up within a day or set a reminder to provide a more definite follow up time within a system-defined placeholder amount of time). Additionally or alternatively, the extractor 232 or augmenter 236 can include or use a candidate term identifier 300 (discussed in greater detail in regard to FIG. 3) that identifies candidate terms from the transcript related to a concepts that potentially merit further clarification to a reader or are of potential interest for follow up to a reader, and generate explanations for those candidate terms to the reader.

In various embodiments, when generating supplemental content 235c of a hyperlink between an extracted key point and a segment from the transcript, the augmenter 236 links the most-semantically-relevant segment with the key point, to allow users to navigate to relevant portions of the transcript 225 via the key points. As used herein, the most-semantically-relevant segment refers to the one segment that provides the greatest effect on the category classifier 234 choosing to select one category for the key point, or the one segment that provides the greatest effect on the extractor 232 to identify the key point within the context of the conversation. Stated differently, the most-semantically-relevant segment is the portion of the conversation that has the greatest effect on how the analysis system 230 interprets the meaning and importance of the key point within the conversation.

Additionally, the augmenter 236 may generate or provide supplemental content 235c for defining or explaining various key terms to a reader. For example, links to third-party webpages to explain or provide pictures of various unfamiliar terms, or details recalled from a repository associated with a key term dictionary, can be provided by the augmenter 236 as supplemental content 235c.

The augmenter 236 may format the hyperlink to include the primary target of the linkage (e.g., the most-semantically-relevant segment), various secondary targets to use in updating the linkage based on user feedback (e.g., a next-most-semantically-relevant segment), and various additional effects or content to call based on the formatting guidelines of various programming or markup languages.

Each of the extractor 232, category classifier 234, and the augmenter 236 may be separate MLMs or different layers within one MLM provided by the analysis system 230. When training the one or more MLMs of the analysis system 230, the MLMs may be trained via a first inaccurate supervision technique and subsequently by a second incomplete supervision technique to fine-tune the inaccurate supervision technique, such as via fine tuning a large language model, and thereby avoid catastrophic forgetting. Additional feedback from the user may be used to provide supervised examples for further training of the MLMs and better weighting of the factors used to identify relevancy of various segments of a conversation to the key points therein, and how those key points are to be categorized for review.

The analysis system 230 provides the analysis outputs 235 to an output device 240 for storage or output to a user. In some embodiments, the output device 240 may be the same or a different device from the audio provider 210. For example, a caregiver may record a conversation via a cellphone as the audio provider 210, and receive and interact with the transcript 225 and analysis outputs 235 of the conversation via the cellphone. In another example, the caregiver may record a conversation via a cellphone as the audio provider 210, and receive and interact with the transcript 225 and analysis outputs 235 of the conversation via a laptop computer.

In various embodiments, the output device 240 is part of a cloud storage or networked device that stores the transcript 225 and analysis outputs 235 for access by other devices that supply matching credentials to allow for access on multiple endpoints.

FIG. 3 illustrates a candidate term identifier 300, according to embodiments of the present disclosure. In various embodiments, the candidate term identifier 300 is provided as an MLM and the associated modules of computer executable code to identify various action items to follow up on based on a conversation and the information included or omitted therefrom.

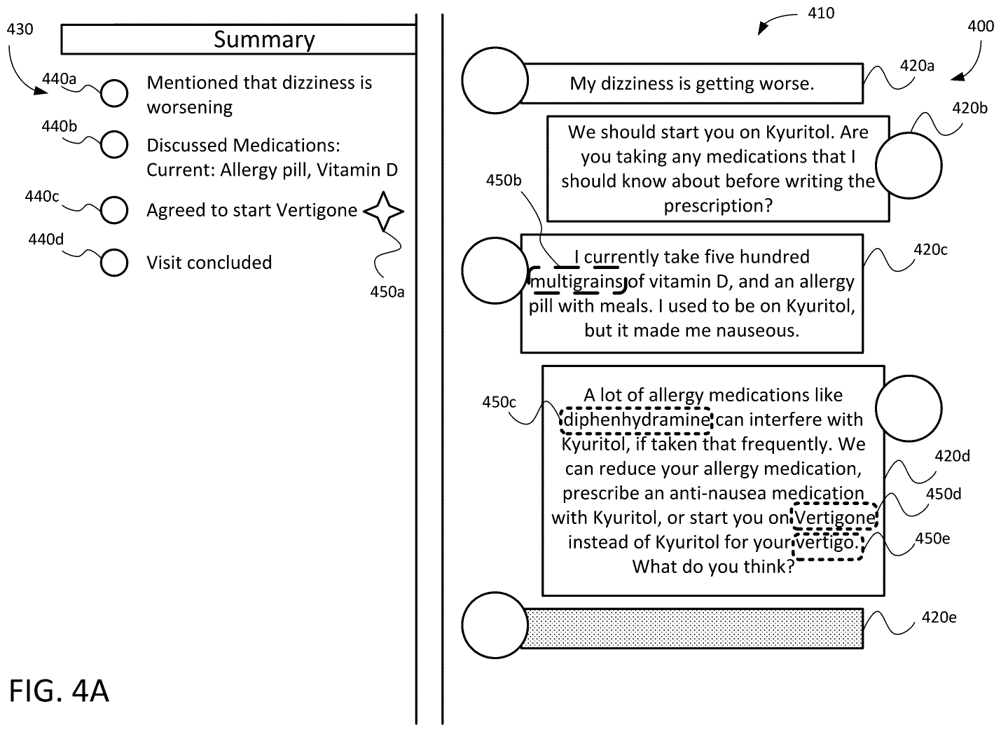

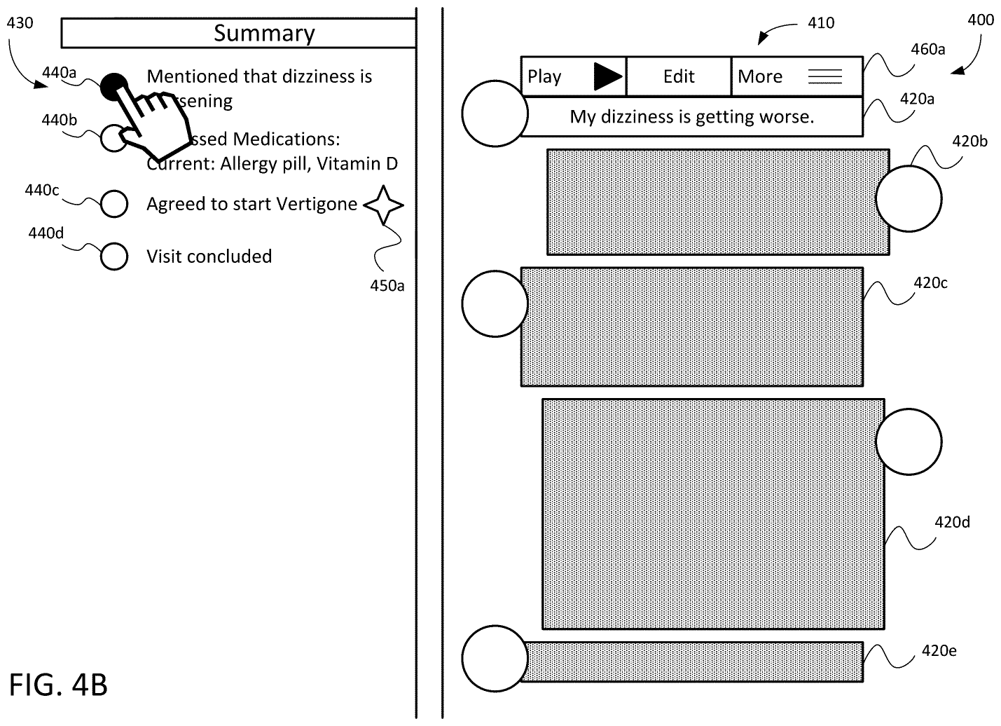

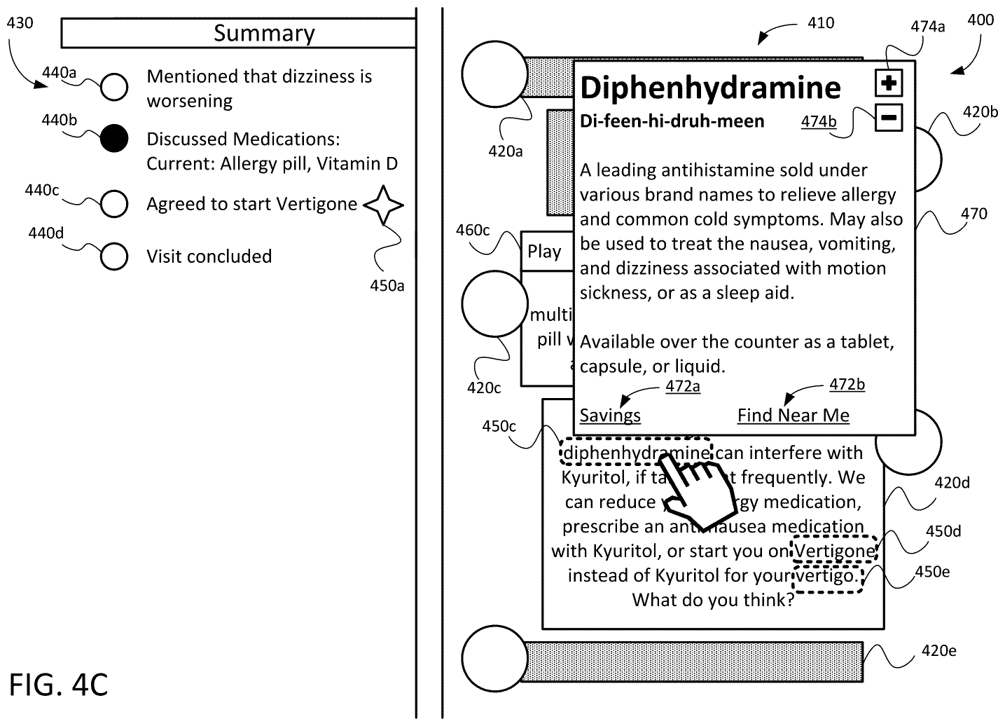

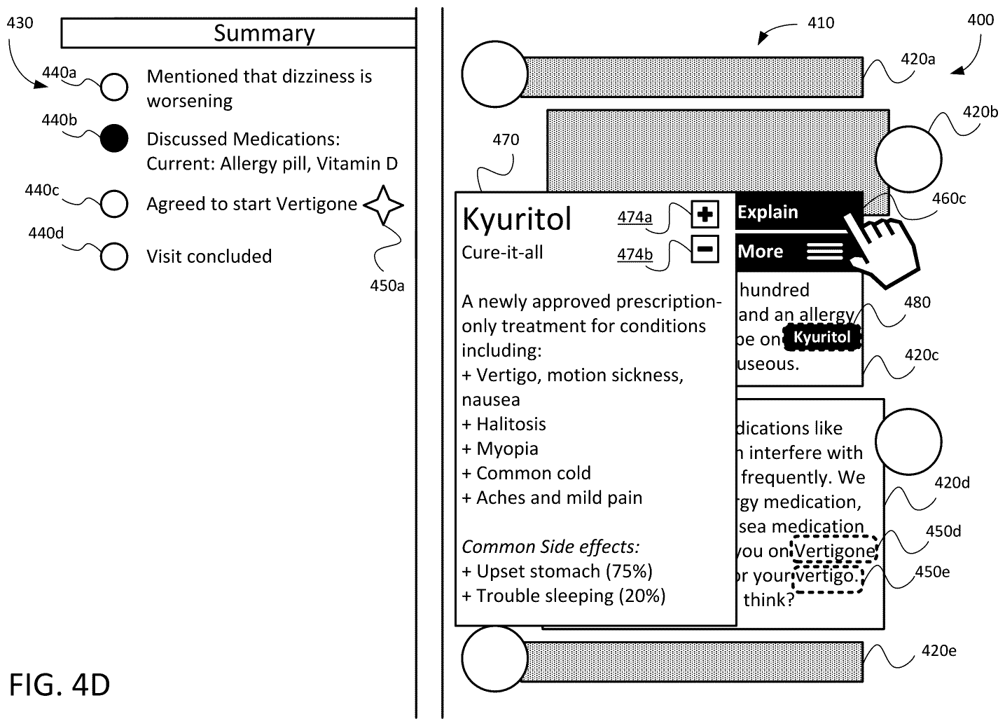

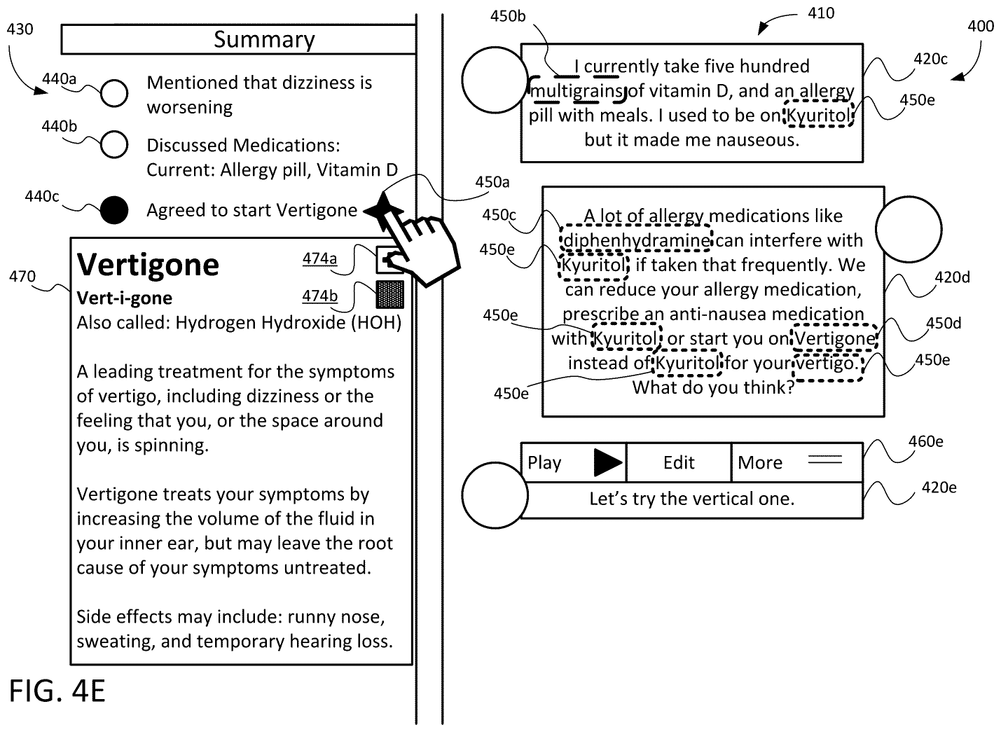

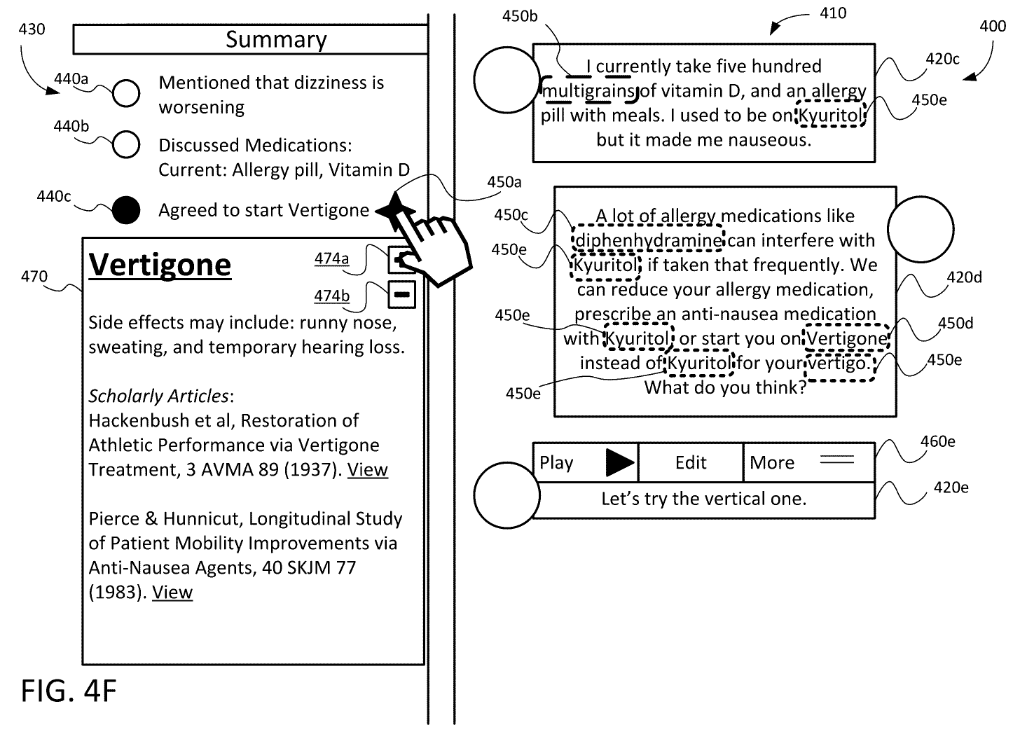

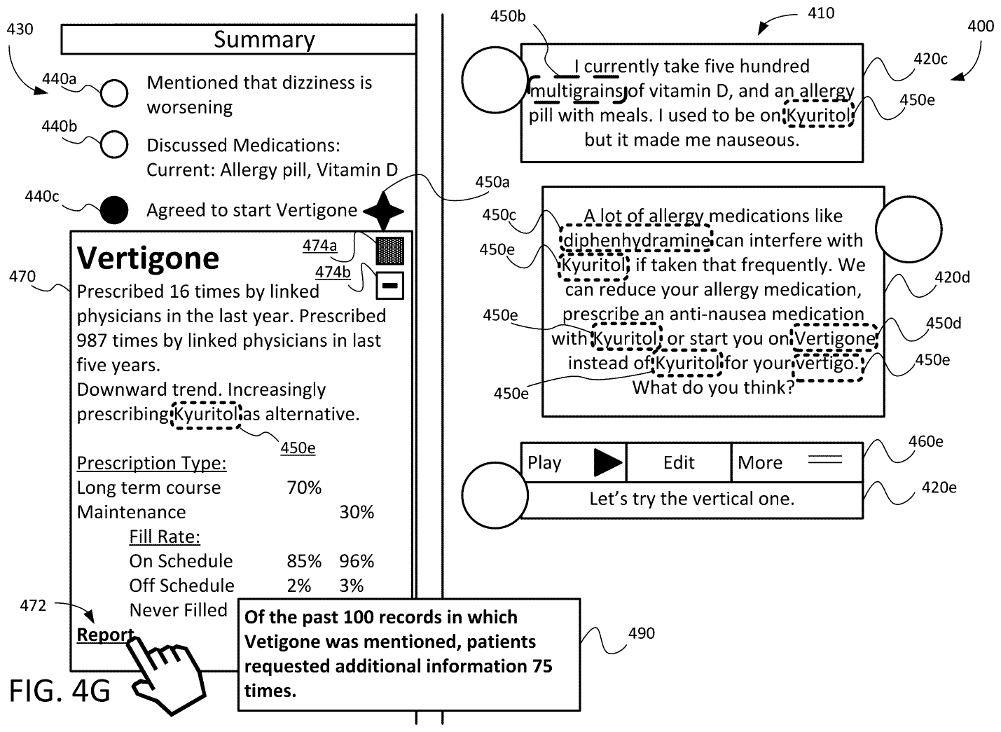

The candidate term identifier 300 includes a term analyzer 310 that analyzes the transcript 225 to identify candidate terms from the transcript 225 for potential explanation to a reader. The term analyzer 310 is in communication with a reader assessor 320 to identify a supplementation level of the reader to identity the types of terms from the transcript 225 to identify as candidate terms, and the supplemental data that are to be provided to the reader. The reader assessor 320 uses one or more of the recording 215, the transcript 225, and a profile database 380 to identify a supplementation level for the reader for the term analyzer to identify relevant candidate terms and an explanation generator 330 to supply relevant explanations 340. The explanation generator 330 creates explanations 340 for the candidate terms based on supplemental data received from supplemental data sources 370, or retrieves previously generated explanations 340 from a storage database 390. A UI Application Program Interface (API) 350 outputs the identifiers for the candidate terms and the explanations 340 to a UI (such as those shown in FIGS. 4A-4G) provided on an output device 240. A network interface 360 outputs the UI elements generated by the UI API 350 to the output device 240, receives interactions with the UI elements from the output device 240, and sends and receives data from supplemental data sources 370 for use by the explanation generator 330 in generating the explanations 340.

The reader assessor 320 identifies a supplementation level for a reader (e.g., the user of the output device 240, which may be a participant of the conversation or a third party with access to the transcript 225) to allow the candidate term identifier 300 to identify what elements of the conversation are of potential interest for further explanation to the reader. Accordingly, the reader assessor 320 may identify the reader as having a first, second, third, etc., level of supplementation, so that the term analyzer 310 may identify different candidate terms and the explanation generator 330 may identify different explanation types for the same candidate terms for two or more readers of different levels of supplementation. In various embodiments, the reader assessor 320 analyzes at least one of the recording 215, the transcript 225, and a profile database 380 to identify the supplementation level of the reader.

As used herein, “supplementation level”, “level of supplementation”, and related terminology refer to an assessed measure of one or more of the predicted ability of a reader to understand a concept and the assessed measure of how curious a reader is in learning more about the concept. The supplementation level is a multivariate representation for how and what to provide as relevant supplemental information to a reader, and uses of “higher” or “lower” to describe different supplementation levels may therefore refer to higher or lower values for a given variable (e.g., grasp of industry jargon, desire to see secondary sources, etc.).

Using the supplementation level, the candidate term identifier 300 identifies candidate terms that should be extracted for a particular reader to provide supplemental data for, and what sort of supplemental data to provide to the reader. In one example, a reader who is assessed to be unfamiliar with automotive terminology (e.g., a new car owner) may have a supplementation level that helps identify mechanical terms from the transcript to provide supplemental data for what the mechanical terms mean, whereas a reader who is assessed to be familiar with automotive terminology (e.g., a mechanic) may have those same terms extracted to provide different supplemental data for alternative parts to use in a repair task related to those terms. In various embodiments, a reader who is assessed with a first supplementation level may be provided with a first set of candidate terms that are at least partially different from a second set of candidate terms that are provided to readers of a second supplementation level. For example, a car owner and a mechanic with different assessed supplementation levels for a transcribed conversation about a service check may both have the term “oil filter” identified as a candidate term, but the car owner also has the term “tire rotation” identified as a candidate term, while the mechanic does not.

In some embodiments, the reader assessor 320 may identify a supplementation level based on profile data for the reader in a profile database 380. For example, the profile data may identify the reader as a class of user associated with a certain supplementation level (e.g., doctor versus patient, student versus teacher, high performing student versus low performing student, mechanic versus owner, junior versus mid-level versus senior technician, etc.), a certain interest level (e.g., a skilled technician of type A versus an equally skilled technician of type B), and combinations thereof.

In addition to or instead of using a profile database 380, when the reader is a participant in the conversation, the reader assessor 320 may analyze the recording 215 and the transcript 225, and associated metadata, to identify the supplementation level of the participant. For example, when the recording 215 includes repeated pauses or breaks in cadence around certain words of a technical nature relative to the rest of the conversation (e.g., via Laplace or frequency domain-analysis), the reader assessor 320 may identify that the reader is unfamiliar with those words, and identify a corresponding supplementation level for the reader. In another example, the reader assessor 320 identifies words in the transcript associated with confidence score in transcription of words of a technical nature below a threshold confidence range (e.g., indicating a potential mispronunciation or mis-transcription) that indicate to the reader assessor 320 that the reader is unfamiliar with those words, which the reader assessor 320 used to identify a corresponding supplementation level for the reader. Additionally or alternatively, when the reader (or another party with access to the transcript 225) corrects the transcription of a term in the transcript 225 (e.g., indicating that the NLP system mis-transcribed a term or that the reader is attempting to substitute an incorrect term believed to be correct into the transcript 225), the reader assessor 320 may identify that the reader or the speaker is unfamiliar with the original term or the term as updated.

In various embodiments, the reader assessor 320 may initially assign a reader a baseline supplementation level that is adjusted (e.g., noting the reader as more junior in a given topic) in response to identifying cues indicating that the reader is unfamiliar with terms or is steering the conversation to cover basic topics related to the term. Similarly, the reader assessor 320 may adjust an initially assigned baseline supplementation level in response to identifying cues indicating that the reader is familiar with terms or steering the conversation to cover advanced topics related to the term. The familiarity cues can include similarities or differences in the conversational cadence when using the term, confidence in the transcription of the recording 215 to the transcript 225, whether the transcript 225 has been updated, and the intents of various segments of the conversation. The reader assessor 320 may be configured in different domains to observe the conversation for different intents that are associated with topics that are considered more basic or more advanced, identify the use of more or less advanced sentence structure or vocabulary (e.g., according to a Flesch-Kincaid score), and may differentiate between the party requesting the information and the party responding with the requested information.

For example, in the example conversation 120 of FIG. 1, the first party 110a misuses several terms and generally uses shorter sentences with shorter words than the second party 110b. Accordingly, when the first party 110a is identified as the reader, the reader assessor 320 may assign the first party 110a a lower supplementation level based on the identified misuses. As more misuses, mispronunciations, and other signs of unfamiliarity with the terms are identified, the reader assessor may continue to lower the supplementation level for the reader. In contrast, the second party 110b uses several technical words correctly and generally uses longer sentences with longer words than the first party 110a. Accordingly, when the second party 110b is identified as the reader, the reader assessor 320 may assign the second party 110b a higher supplementation level based on the identified correct and confident uses of technical terms (e.g., correct pronunciation, constant rate of speech with surrounding terminology, confidence in transcription above a threshold value).

In various embodiments, the reader assessor 320 is provided with a list of terms appropriate for the domain of the conversation to identify the correct usage thereof when assessing the supplementation level of a reader who is a party 110 to the conversation. Accordingly, the reader assessor 320 may focus attention on the misuse, mispronunciation, or lack of confidence when using certain terms based on the domain identified for the conversation. For example, if a party 110 is discussing maintenance of a vehicle and misuses the term “carburetor”, the misuse may affect the supplementation level for that party 110 if the conversation is evaluated in an automotive maintenance domain, but not in relation to a musical domain (e.g., if the term arose as an aside to a conversation regarding music).

The term analyzer 310 uses various features of the terminology used in the conversation to identify various terms as candidate terms to provide supplemental data for. In various embodiments, the features include a frequency of use of a term (and which party 110 is using the term); a tone at which a party is using a term (e.g., whether a party 110 is misusing, mispronouncing, hesitating, or otherwise using an atypical cadence when using the term); whether a party 110 is using the term in a question, reply, or statement; whether the transcription of the recording 215 to a corresponding word or group of words in the transcript 225 is within a confidence threshold (e.g., whether the speaker is using an unusual pronunciation even when the term is properly transcribed); and combinations thereof.

For example, a term used less frequently in the conversation may be of greater interest to a reader having a supplementation level associated with novices (e.g., a novel term) than to a reader of an expert supplementation level (e.g., a term not central to the conversation), particularly if the speaker using the word is not the reader. In another example, a term that is spoken at a different rate or using a different tone than the average rate or tone used by the speaker in the conversation may indicate that the term is novel (e.g., slowing down to pronounce a difficult or unfamiliar term), that the speaker is providing emphasis on the term, and thus is provided greater weight as a candidate term. Accordingly, the term analyzer 310 may use frequency analysis of the recording 215 or transcript 225 as a whole, and segments thereof, in addition to or instead of identifying individual words or phrases to identify as candidate terms.

In various embodiments, the term analyzer 310 identifies the candidate terms from the transcript 225 according to the identified supplementation level for the reader. For example, a reader of a lower compression level may be interested in different topics (and the related candidate) terms than a reader of a higher supplementation level. Using the conversation 120 from FIG. 1 as an example, the first party 110a may be unfamiliar with the term “diphenhydramine” while the second party 110b may be very familiar with the term, as it is the chemical name of a common allergy medication. Accordingly, the term analyzer 310 may identify “diphenhydramine” as a candidate term when the first party 110a is the reader, but may not identify “diphenhydramine” as a candidate term when the second party 110b is the reader.

An explanation generator 330 generates explanations 340 for the identified candidate terms in a human-readable format according to the level of supplementation identified by the reader assessor 320. The explanations 340 include information in a human-readable format that provide additional information related to a candidate term. In various embodiments, the explanations 340 may include metadata or machine-readable data that are not presented to human readers, such as hypertext references to various external websites or supplemental data sources 370 from which data values in the explanation 340 can be updated. The explanations 340 may be formatted according to various file formats, such as the extensible markup language (XML), to allow the insertion (or removal) of the explanation 340 into a text file for the transcript 215 so that an application on a reader device can differentiate the explanation 340 from the transcript 215 and provide each in an appropriate portion of the UI when requested by a reader.

In various embodiments, the explanation generator 330 may retrieve previously generated explanations 340 for the candidate terms from a storage database 390, or may query an external supplemental data source 370 for additional data to use in generating a new explanations 340 or supplementing previously generated explanations 340. In various embodiments, the query (to the supplemental data source 370 or the storage database 390) is formatted as a prompt-line query for a search engine, a Structured Query Language (SQL) query, a deductive query language, an object query language, or the like, and includes the candidate term to generate or retrieve an explanation 340 for, and may optionally include one or more of: a list of permitted sources to access, synonyms to the candidate term, additional terms and logical operators for relationships (e.g., OR and synonyms, NOT and words to exclude, AND and words to include, WITHIN and words to find within a specified range of the candidate term, etc.), date ranges of results to accept from the source, result types to accept from the source (e.g., file types, location of matching data in the resource), and the like.

As used herein, supplemental data refers to data obtained outside of the transcript 225 of the conversation. A user may specify which systems the network interface 360 is permitted to access to obtain supplemental data from, which may be based on the identity of class of the user. For example, a doctor may specify that the network interface 360 is to use (or exclude) various sources when the reader is a patient of a first supplementation level and a different set of sources to use (or exclude) when the reader is the doctor or a patient of a second supplementation level. Accordingly, a user may use the supplementation level to select an appropriate (and approved) supplemental source 370 to base an explanation 340 on to aid the reader's understanding and provide supplemental data of interest to the reader.

In various embodiments, when querying a supplemental data source 370 via the network interface 360, the explanation generator 330 processes the returned results from the supplemental data source 370 similarly to how the transcript 225 of the conversation was processed. Accordingly, the explanation generator 330 may provide the retrieved results to the analysis system 230 to generate a summary of returned results for use as the explanation 340. By controlling the summarization of the data retrieved from the supplemental data source 370 using the process used to generate the transcript 225 and summary thereof, the explanation generator 330 can match the look and feel of an explanation 340 to the summary of the conversation. By matching the look and feel of the transcript 225 and the readouts (235a) that provide a summary of the key points identified therein, the explanation generator 330 improves the readability of the returned results in context with the transcript 225, maintains the impression that the user is viewing content generated by the NLP system, and keeps the users within the UI environment provided in conjunction with the NLP system rather than sending the users to external parties to research the candidate term on their own.

For example, data taken from a source webpage unrelated to the conversation (e.g., the participants and the host of the webpage are third parties to one another) are processed by the extractor 232 to create a summary includes readouts (235a) of the key points from the returned results using the same model used to create the summarized readouts (235a) of the transcript 225, and may include inputs from the transcript 225 such as preferred vocabulary (e.g., synonyms to use) to match the explanation 340 to the vocabulary used in transcript 225. The explanation 340 therefore represents a composite summarization that combines certain vocabulary and grammatical elements of a base conversation (and summary thereof) with the content of a third party supplemental data source 370.

In various embodiments, the interactions between the reader and the UI elements in which the reader requests, views, or rates the explanation 340 are used as feedback for the MLMs used by the term analyzer 310, reader assessor 320, and explanation generator 330 to identify more-relevant supplemental data to provide to the readers, and to improve the assessment of the reader into a given level of supplementation.

For example, whether a reader selects a candidate term for further explanation can be used to identify whether that candidate term is of interest to other users of a shared supplementation level with the reader. In another example, whether a reader selects a candidate term for further explanation can be used to identify whether the reader is assigned to the most appropriate supplementation level, or if the reader is selecting candidate terms more similarly to readers assigned to a different supplementation level.

In various embodiments, the candidate term identifier 300 is a module included in, or available for use with, the extractor 232 or augmenter 236, and may use the outputs from the extractor 232 or augmenter 236 as inputs, or provide identified candidate terms as inputs for use by the extractor 232 or augmenter 236. The candidate term identifier 300 allows the system to generate explanations 340 for provision to participants of the conversation (e.g., to the output device 240) and messages to non-participant entities (e.g., supplemental data sources 370) used in the creation and provision of the explanations 340.

In various embodiments, the candidate term identifier 300 may operate on a completed transcript 225 (e.g., after the conversation has concluded) or operate on an in-progress transcript 225 (e.g., while the conversations is ongoing). Accordingly, the candidate term identifier 300 may generate explanations 340 or UI elements to trigger UI generation while the conversation is ongoing. For example, during an ongoing conversation, the candidate term identifier 300 may identify a candidate term for “carburetor” from a partial transcript 225 and generator a UI element related to a live transcription of that conversation associated with “carburetor”. When the candidate term identifier 300 and receives selection of that UI element, the candidate term identifier 300 can generate or otherwise provide an explanation to the reader at an appropriate supplementation level for supplemental data related to carburetors. Accordingly, a novice reader may be provided with an explanation 340 for what a carburetor is, while the conversation is ongoing, to better understand the scope of the conversation. Similarly, an experienced reader may be provided with an explanation 340 for situations where fuel injectors are preferred over carburetors or models of carburetors to use in a discussed vehicle, while the conversation is ongoing, to provide greater understanding of the related topics.

The candidate term identifier 300 uses the network interface 360 to communicate the queries for supplemental data to the various supplemental data sources 370, receive user interactions with the transcript 225 and various UI elements from the output device 240, and transmit updated or new UI elements (including the explanations 340) to the output device 240. The network interface 360 transmits the queries that include requests for additional data for various candidate terms to various supplemental data sources 370. Additionally, the network interface 360 provides explanations 340 as UI elements (e.g., via the UI API 350) to the output device 240, and updates the UI API 350 as the user interacts with the UI elements.

FIGS. 4A-4G illustrate interactions with a Graphical User Interface (GUI) 400 that displays a transcript and candidate terms identified from a conversation, according to embodiments of the present disclosure. Using the conversation 120 from FIG. 1 as a non-limiting example, the GUI 400 illustrated in FIGS. 4A-4G shows a perspective for a caregiver-adapted interface, but in various embodiments, other conversations may relate to different conversational domains taken from different perspectives than those illustrated in the current example.

FIG. 4A illustrates a first state of the GUI 400, as may be provided to a user after initial analysis of an audio recording of a conversation by an NLP system. The transcript is shown in a transcript window 410, which includes several segments 420a-420e (generally or collectively, segment 420) identified within the conversation. In various embodiments, the segments 420 may represent speaker turns in the conversation, sentences identified in the conversation, topics identified in the conversation, a given length of time in the conversation (e.g., every X seconds), combinations thereof, and other divisions of the conversation.

Each segment 420 includes a portion of the written text of the transcript, and provides a UI element that allows the user to access the corresponding audio recording, make edits to the transcript, zoom in on the text, and otherwise receive additional detail for the selected portion of the conversation. Although the transcript illustrated in FIGS. 4A-4G includes the entire conversation 120 given as an example in FIG. 1, in various embodiments, the GUI 400 may omit portions of the transcript from initial display. For example, the GUI 400 may initially display only the segments 420 from which key terms or candidate terms (e.g., to skip introductory remarks or provide a summary), with the non-displayed segments 420 being omitted from display (e.g., positioned “off screen” for later access), shown as thumbnails, etc.

In various embodiments, additional data or metadata related to the segment 420 (e.g., speaker, topic, confidence in written text accurately matching input audio, whether edited by a user) can be presented based on color or shading of the segment 420 or alignment of the segment 420 in the transcript window 410. For example, the first segment 420a, the third segment 420c, and the fifth segment 420e are shown as left-aligned versus the second segment 420b and the fourth segment 420d, which are shown as right-aligned, which indicates different speakers for the differently aligned segments 420. In another example, the fifth segment 420e is displayed with a different shading than the other segments 420, which may indicate that the NLP system is confident that human error is present in the fifth segment 420e, that the NLP system is not confident in the transcribed words matching the spoken utterance, or another aspect of the fifth segment 420e that deserves additional attention from the user.

Depending on the display area available to present the GUI 400, the transcript window 410 may include some or all of the segments 420 at a given time. Accordingly, although not illustrated, in various embodiments, the transcript window 410 may include various content controls (e.g., scroll bars, text size controls, etc.) to enable access to more content than can be legibly displayed at one time on the device outputting the GUI 400. For example, content controls can allow a user to scroll to currently off-screen elements, zoom in on elements below a size threshold or presented as thumbnails when not selected, or the like.

Outside of the transcript window 410, the GUI 400 displays a summary window 430 with one or more summarized representations 440a-d (generally or collectively, representation 440). The representation 440 provide summarizations of the key points extracted from the conversation and selectable controls that, in response to selection by a user, adjust the display of the segments 420a in the transcript window 410 to highlight the segments on which the selected representation 440 is based. Accordingly, the representation 440 allow for easy navigation of the transcript based on the extracted summaries.

In various embodiments, the GUI 400 displays various indicators 450a-e (generally or collectively, indicators 450) for the candidate terms in one or both of the transcript window 410 and the summary window 430. Depending on the underlying reason why the NLP system identified a given term as a candidate term, and where the candidate term is identified, the GUI 400 may display the indicators 450 with different colors, text effects, outline effect, animations, icons, or the like to indicate differences underlying the identified candidate terms or where the indicators 450 are displayed. For example, as illustrated in FIG. 4A, the first indicator 450a is provided as an icon in the summary window 430 in association with the third representation 440c, whereas the second through fifth indicators 450b-e are shown in the text of the segments 420 in which the associated candidate terms appear. Similarly, the second indicator 450b is shown with a different text effect (e.g., a different outline type) than the third through fifth indicators 450c-e, which may be the result of the candidate term of “multigrains” being identified as a misusage, while the candidate terms of “diphenhydramine”, “Vertigone”, and “vertigo” were identified as key terms based on unfamiliarity to a potential reader.

FIG. 4B illustrates selection of the first representation 440a in the GUI 400. When a user, via input from one or more of a keyboard, pointing device, voice command, or touch screen, selects a representation 440 or other selectable representation, the GUI 400 may update the display to include various contextual controls 460a-d (generally or collectively, contextual control 460) or highlight related elements in the GUI 400 to the selected element. For example, when selecting the first representation 440a, the GUI 400 updates to include first contextual controls 460a in association with the first segment 420a to allow editing or further interaction with the underlying action audio and textual elements from the conversation.

For example, the first contextual controls 460a may offer the user the ability to playback the audio of the transcribed first segment 420a, to edit the transcript, submit feedback to the NLPs that generate the transcript or other extracted elements based on the transcript, request supplemental data or the like. As is discussed in greater detail in regard to FIG. 4D, the contextual controls 460 may include various options and contextual cues based on the context of the representation 440 and underlying action item.

Additionally, the GUI 400 adjusts the display of the transcript to highlight the most-semantically-relevant segment 420 to the selected representation 440 for a summarized key term. When highlighting the most-semantically-relevant segment 420, the GUI 400 may increase the relative size of the most-semantically-relevant segment 420 to the other segments, but may also change the color, apply an animation effect, scroll which segments 420 are displayed (and where) within the transcript window 410, and combinations thereof to highlight the most-semantically-relevant segment 420 to the selected representation 440. In various embodiments, each representation 440 includes a hyperlink to the corresponding most-semantically-relevant segment 420. The hyperlink includes the location of the most-semantically-relevant segment 420 within the transcript and any effects (e.g., color, animation, resizing, etc.) to apply to the corresponding segment 420 when the representation 440 is selected to thereby highlight it as the most-semantically-relevant segment 420 for the selected representation 440.

Although shown in FIG. 4B with one segment 420 (the first segment 420a) being highlighted in response to receiving a selection of the first representation 440a, in various embodiments, one representation 440 may highlight two or more segments 420 when selected if relevancy carries across segments 420, such as in FIGS. 4E-4G. Additionally, multiple representations 440 may indicate a shared (e.g., the same) segment 420 as the respective most-semantically-relevant segment 420. Accordingly, when a user selects different representations 440 associated with a shared segment 420, the GUI 400 may apply a different animation effect or new color to the most-semantically-relevant segment 420 to indicate that the later selection resulted in re-highlighting the same segment 420.

By highlighting the segment(s) 420 believed to be the most-semantically-relevant segment(s) 420 to a selected element of the summary of the conversation, the GUI 400 provides the user with an easy way to navigate to relevant segments 420 of the transcript to review surrounding information related to a core concept that resulted in the identification of the key points on which the summary is based. The GUI 400 also provides insights into the factors that most influenced the determination that a given segment 420 is the “most-semantically-relevant” segment 420 so that the user can gain confidence in the underlying NLP system's accuracy or correct the misinterpreted segment 420 to thereby have a larger effect on improving the NLP system's accuracy in future analyses.

For example, the conversation presented in the GUI 400 may include various ambiguities in interpreting the spoken utterances that the user may wish to fix. These ambiguities may include spoken-word to text conversions (e.g., did the speaker say “sea shells” or “she sells”), semantic relation matching (e.g., whether pronoun A is related to noun A or to noun B), and relevancy ambiguity (e.g., whether the first discussion of the key point is more relevant than the second discussion). By exposing the “most-semantically-relevant” segment 420 to a key point, the user can adjust the linkage between the given segment 420 and the key point to improve later access and review of the transcript, but also provide feedback to the NLP system related to the highest-weighted element from the transcript. Accordingly, the additional features provided by the GUI 400 improves both the user experience and the computational efficiency and accuracy of the underlying MLM models.

FIG. 4C illustrates user selection of an indicator 450 for a candidate term in a segment 420 and the provision of supplemental data to the reader. As illustrated, the user has selected the third indicator 450c for “diphenhydramine” in the fourth segment 420d and is provided with an informational window 470 that includes content generated by the NLP system related to diphenhydramine.

In various embodiments, the contents of the informational window 470 include the text of an explanation (340) generated by the NLP system according to a supplementation level for the reader, but may also include various follow-up action controls 472a-b (generally or collectively, action controls 472) that are generated based on the supplementation level of the reader and the candidate term and feedback controls 474a-b (generally or collectively, feedback controls) for the reader to indicate perception on the content of the explanation back to the NLP system.

In the illustrated example, the first action control 472a may provide a hyperlink for coupons for diphenhydramine, and the second action control 472b may provide a hyperlink to a map application to identify locations where the reader can purchase diphenhydramine. In another example, an action control 472 may provide a reader with a hyperlink to a regulatory agency's reports on diphenhydramine, scholarly articles related to diphenhydramine, or the like. Although illustrated in FIG. 4C with two action controls 472a-b, the informational window 470 may include more than or fewer than two action controls 472 in various embodiments.

In the illustrated example, the first feedback control 474a is illustrated as a button with a “+” to elicit feedback from the reader when a more detailed explanation (e.g., more advanced) is desired than the current explanation. Similarly, the second feedback control 474b is illustrated as a button with a “−” to elicit feedback from the reader when a more basic (e.g., less detailed) explanation is desired than the current explanation. Although illustrated in FIG. 4C with two feedback controls 472a-b in a more/less detail schema, the informational window 470 may include more than or fewer than two feedback controls 474 in various that are used in various feedback schemes, such as like/dislike, longer/shorter, more detail/good detail/less detail, or the like.

In various embodiments, the NLP system may receive the feedback from the feedback controls 474 to immediately provide a new explanation in the “next” different supplementation level in an indicated direction, thereby updating the content in the informational window 470 and allowing the reader to “navigate” different supplementation levels. This navigation may be for the current informational window 470 or may be applied globally for the reader in various embodiments. Stated differently, after submitting feedback in a first informational window 470, the reader may see explanations for the new supplementation level in the first informational window 470 and optionally in other informational windows 470. Additionally or alternatively, the NLP system may receive the feedback from the feedback controls 474 to adjust how the reader is evaluated for a given supplementation level for future provision of explanations.

FIG. 4D illustrates user selection of terms from the transcript that were not initially identified by the NLP system as candidate terms for the provision of supplemental information. As illustrated, the term “Kyuritol” was not initially identified by the NLP system as a candidate term to provide an explanation (340) for, but the reader has selected the reader-selected term 480 of “Kyuritol” from the third segment 420c (e.g., via a cursor, touch-screen, or other input device). After selecting the desired word or phrase from the segment 420 as the reader-selected term 480, the reader has selected a command via the third contextual controls 460c to request that the NLP system explain the reader-selected term 480.

In response to the reader requesting an explanation of a reader-selected term 480, the NLP system generates and returns an explanation for the term that is then provided to the reader via an informational window 470. In various embodiments, the NLP system processes the reader-selected term 480 as the NLP system would process a candidate terms identified from the transcript by the NLP system; by querying a supplemental data source (370) and reformatting the response for provision as an explanation (340) or querying a storage database (390) for a previously generated explanation (340) for the reader-selected term 480. Once the user device receives the explanation (340) from the NLP system, the GUI 400 is updated to display the informational window 470 that includes the explanation (340).

In various embodiments, after a reader requests an explanation for a reader-selected term 480, the NLP system and the reader device treat the reader-selected term 480 as though the term were identified as a candidate term by the NLP system, and the reader device may update the GUI 400 to display an indicator 450 in association with the term in one or both of the transcript window 410 and summary window 430.

For example, as is illustrated in FIGS. 4E-4F, after “Kyuritol” is selected as a reader-selected term 480 to treat as a candidate term, the GUI 400 may include one or several instances of a fifth indicator 450e in association with the instances of “Kyuritol” in the segments 420 of the transcript. In various embodiments, the GUI 400 may include a corresponding one indicator 450 for each use of the candidate term, one indicator 450 for each candidate term (e.g., the first) in a given segment 420 or window (including the transcript window 410, summary window 430, and informational window 470), or one indicator 450 for a given candidate term at a time during display of the GUI 400 (e.g., in which the given candidate term may be updated as the display of the GUI 400 reduces or increases the size or position of various candidate terms in the display space).

Additionally, when the NLP system receives a selection of a reader-selected term 480, the NLP system can use the selection as feedback for one or more of: what terms to identify for other readers of the same supplementation level as the current reader in future analysis, and what supplementation level the current reader should be assigned.

Although the examples illustrated in FIGS. 4C and 4D discuss providing the informational window 470 to the reader in response to the reader selecting an indicator 450, in various embodiments (e.g., based on the supplementation level), the GUI 400 may automatically select the associated indicator 450 without direct user interaction. For example, the GUI 400 may automatically select the indicator 450 when playing back audio of the conversation that includes a candidate term (e.g., displaying the informational window 470 of FIG. 4C when playing back “diphenhydramine” and the surrounding terms until the reader dismisses the informational window 470 or another window is requested). In another example, one or more informational windows 470 are displayed when the GUI 400 is first provided or in response to the reader selecting a representation 440 that causes the segment 420 in which an indicator 450 is included to be highlighted.

In some embodiments, when the informational window 470 is generated based on a user interacting with elements displayed in the segments 420 (e.g., as in FIGS. 4C and 4D), the informational window 470 is generated within the transcript window 410, and may overlay or obscure some of the segments 420 or shift the display of the segments 420. In various embodiments, an informational window 470 generated within the transcript window 410 may be confined therein to avoid overlapping or shifting the display of the representations 440 and other elements displayed in the summary window 430. Similarly, as is shown in FIGS. 4E-4G, when the informational window 470 is generated based on a user interacting with elements displayed in summary window 430, the informational window 470 is generated within the summary window 430, and may overlay or obscure some of the representations 440 or shift the display of the representations 440. In various embodiments, an informational window 470 generated within the summary window 430 may be confined therein to avoid overlapping or shifting the display of the segments 420 and other elements displayed in the transcript window 410.

In various embodiments, the GUI 400 may permit the concurrent display of multiple informational windows 470, or may restrict the display to one informational window 470 at a time. In various embodiments, when the GUI 400 permits only a single informational window 470 to be displayed at a time, the informational window 470 is a modal control that requires dismissal before other elements in the GUI 400 outside of the informational window 470 may be interacted with.

FIG. 4E-4G illustrate user selection of an indicator 450 for a candidate term outside of a segment 420 (e.g., in a representation 440 or an indicator in the summary window 430) and the provision of supplemental data to the reader. In each of FIGS. 4E-4G, a reader has selected the third representation 440c, which highlights the fourth segment 420d and the fifth segment 420e in the transcript window 410 (related to the portion of the conversation that the NLP system used to identify the that parties “agreed to start Vertigone”), and the reader has selected the first indicator 450a related to “Vertigone” to display an informational window 470 related to Vertigone.

Although each reader has performed the same actions in relation to the same conversation in FIGS. 4E-4G, the GUI 400 can show different information or arrangements thereof associated in the informational window 470 for readers identified as having different supplementation levels. Additionally or alternatively, a reader may request a different supplementation level from what is initially provided by the NLP system by using the feedback controls 474a-b. As shown in FIG. 4E, the feedback control 474b to request a more basic explanation is grayed out (and may be unselectable when a more basic explanation is not available. Similarly, as shown in FIG. 4G, the feedback control 474a to request a more detailed explanation is grayed out (and may be unselectable when a more detailed explanation is not available). In some embodiments, one or more of the feedback controls 474 may be presented with graying or other indicia to alert the reader when navigation to a different supplementation level is not available via the feedback controls 474, but selection of the feedback controls 474 may still provide feedback on the reader's perception of the explanation. However, in some embodiments, even when navigation to a different supplementation level is not available via the feedback controls 474, the feedback controls 474 may be presented without indicia of disabled navigation (e.g., as normal or active) to encourage the reader to provide feedback in relation to the explanation.

FIG. 4E illustrates provision of an explanation (340) for a first supplementation level that describes what the candidate term of “Vertigone” refers to in basic terms, for example, for a non-expert reader. FIG. 4F illustrates provision of an explanation (340) for a second supplementation level that provides additional information (and action controls 472) for accessing supplemental data sources. As illustrated in both of FIG. 4E and 4F, the informational windows 470 includes a data element related to the side effects associated with Vertigone, but presents basic explanations for what Vertigone is in FIG. 4E (e.g., for a novice reader) and action controls 472a-b that link to scholarly articles related to Vertigone in FIG. 4F (e.g., for an expert user). In various embodiments, a third party or the reader may specify what supplemental data sources can be used to draw the data used to generate the contents for the informational window 470 from to ensure that the reader is provided with accurate information that the reader has the ability to access. For example, a physician associated with the reader in FIG. 4E may specify what sources can be used to draw the content for the explanation from, while the reader in FIG. 4F may specify what journals the reader has access to so that the informational window 470 does not include invalid hyperlinks or hyperlinks to inaccessible content.

FIG. 4G illustrates provision of an explanation (340) for a third supplementation level that provides additional information for a reader different than the information provided in either of FIG. 4E or 4F. For example, the third supplementation level may be for readers identified as physicians or other providers that may have an expert understanding, but a different motivation for reviewing the conversation than the readers assigned the first or second supplementation levels (e.g., patients).

In various embodiments, when providing the explanation (340) based on the supplementation level of the reader, the NLP system may draw from different data sources to provide the explanation (340) and from the use statistics of the NLP system itself. For example, in FIG. 4G, the informational window may include statistics related to the provision and adherence to regimens of Vertigone that are available to physician readers that are otherwise unavailable to patient readers that are extracted from an EMR database accessible to the physician reader, but not patient readers.

The NLP system can generate an aggregation report 490 to indicate how often associated users have, in aggregate, requested supplemental information for a certain candidate term. The aggregation report 490 may provide the reader (e.g., in response to selecting an associated action control 472) with statistics related to how often other readers (or readers of a given classification) have selected various indicators 450. In various embodiments, the aggregation report 490 may filter the request for supplemental information based on the supplementation level of the readers, a class of the readers, or other metrics. Accordingly, in one example, the NLP system may provide a physician reader with an indication for how often patient-class readers have requested additional information about a given concept based on which indicators 450 have been recently selected by patient-class readers (e.g., to identify areas of self-improvement, trends in patient interest, etc.). In another example, a professor may receive an aggregation report 490 from an NLP system that indicates how often A-students, B-students, and C-students respectively accessed explanations for various candidate terms from a transcribed lecture.

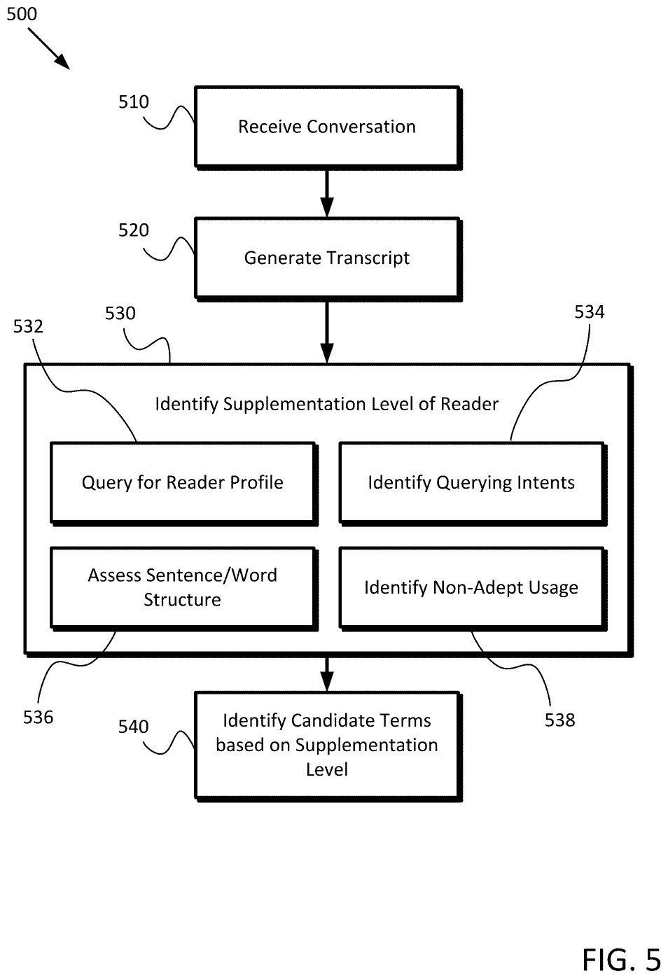

FIG. 5 is a flowchart of a method 500 for identifying candidate terms for a reader from a conversation, according to embodiments of the present disclosure. Method 500 begins at block 510, where an NLP system (such as the NLP system including the speech recognition system 220 and analysis system 230 discussed in relation to FIG. 2) receives a conversation that includes utterances spoken by two or more parties. In various embodiments, the recording may be received from a user device associated with one of the parties, and may include various metadata regarding the conversation. Such metadata may include one or more of: the identities of one or more parties, a location where the conversation took place, a time where the conversation took place, a name for the conversation or recording, a user-selected topic of the conversation, whether additional audio sources exist for the same conversation or portions of the conversation (e.g., whether two or more parties are submitting separate recordings of one conversation), etc.

At block 520, a speech recognition system or layer of the NLP system generates a transcript of the conversation included in the recording received at block 510. In various embodiments, the speech recognition system may perform various pre-processing analyses on the audio of the recording to remove background noise or non-speech sounds to aid in analysis of the recording, or may receive the recording having already been processed to emphasize speech. The speech recognition system applies various attention-based models to identify the written words corresponding to the spoken phonemes in the recording to produce a transcript of the conversation. In addition to the phoneme matching, the speech recognition system uses the syntactical and grammatical relationship between the candidate words to identify an intent of the utterance and thereby select words that better match a valid and coherent intent for the natural language speech included in the recording.

In various embodiments, the speech recognition system may clean up verbal miscues, add punctuation to the transcript, and divide the conversation into a plurality of segments to provide additional clarity to readers. For example, the speech recognition system may remove verbal fillers (e.g., “um”, “uh”, etc.), expand shorthand terms, replace or supplement jargon terms with more commonplace synonyms, or the like. The speech recognition system may also add punctuation based on grammatical rules, pauses in the conversation, rising or falling tones in the utterances, or the like. In some embodiments, the speech recognition system uses the various sentences (e.g., identified via the added punctuation) to divide the conversation into segments, but may additionally or alternatively use speaker identities, shared topics/intents, and other features of the conversation to divide the conversation into segments.

At block 530, an analysis system or layer of the NLP system identifies the supplementation levels of the reader. In various embodiments, the reader may be a party to the conversation who is reviewing the conversation via the transcript, or a third-party that was not initially part of the conversation. For non-participant readers, the analysis system or layer of the NLP system may perform sub-block 532 and omit sub-blocks 534, 536, and 538, while for participant reader, the NLP system may perform some or all of sub-blocks 532, 534, 536, and 538. In various embodiments, when the NLP system performs more than one of sub-blocks 532, 534, 536, and 538 as part of block 530, the NLP system may use different weights in the analyses of different factors, which can be adjusted according to user preferences or via an MLM model using feedback from users and selected candidate terms to judge how appropriately previous supplementation levels were identified to adjust how to weight the different factors.

At sub-block 532, the NLP system queries for a reader profile associated with the reader. In various embodiments, the reader may select a supplementation level or have a previously established profile that indicates the supplementation level to use for the reader. The NLP system may store the supplementation levels as part of a reader profile locally or in a cloud or offsite memory, or may receive a reader profile that is stored locally on a reader device (or a cloud or offsite memory specified by the reader). When querying for the reader profile, the NLP system may use the credentials or selections received from the reader to select a predefined supplementation level for the reader, or adjust a baseline supplementation level based on previous reader interactions

For example, a reader may select between student and teacher supplementation levels to receive a supplementation level respectively tuned to students or teachers for a given subject when reviewing the transcript of a lecture. In another example, the NLP system may select between supplementation levels for new patients, existing patients, treating care providers (who were party to the conversation), reviewing care providers (who were not party to the conversation), or other classes of reader based on provided credentials for the reader. In another example, the reader or the NLP system may initially select a first supplementation level, but based on prior reader behavior (e.g., selecting or not selecting various explanations identified by the NLP system, requesting explanations for candidate terms not initially highlighted as such by the NLP system, etc.), further analysis of the transcript (when the reader is a participant to the conversation per sub-blocks 534, 536, and 538), and combinations thereof, the NLP system can adjust the reader to have a different supplementation level.

At sub-block 534, the NLP system identifies querying intents in the conversation associated with the reader as a speaker. When the reader is a participant in the conversation, the NLP system identifies the utterances that were spoken by the reader, and identifies which of those utterances included an intent to query for more information. Similarly, the NLP system can identify when the reader (as a speaker in the conversation) is responding to utterances that have querying intents (e.g., answering questions posed by another party). Accordingly, the NLP system can evaluate whether the reader is unfamiliar or interested with a concept that includes a candidate term (e.g., posing initial or follow-up questions) or familiar with the concept that includes the candidate term (e.g., responding to questions, posing follow-up questions), and thereby adjust or set the supplementation level for the reader.

In various embodiments, the NLP system may identify whether an utterance has a querying intent based on the grammatical and syntactical rules of the language being spoken in the conversation. For example, in English language utterances, the NLP system can identify querying intent based on a rising tone in the utterance, a word order of the utterance (e.g., “Did I do that?” vs. “I did do that”), the presence of question-related words or participles (e.g., the inclusion of who, what, where, when, why, how; sentences ending with “eh?”, “right?”, or other words inviting a response; etc.), the presence of repeated words in the next utterance from a different party (e.g., an answer to the question), whether the next utterance (from the same or a different party) also includes querying intent (e.g., a follow-up question), and combinations thereof.

At sub-block 536, the NLP system assesses the sentence and word structure of the utterances spoken by the reader during the conversation. In various embodiments, the NLP system identifies whether the reader (as a speaker) is using more basic or more advanced versions related to known candidate terms. For example, when a speaker uses the full name of a candidate term (e.g., “fuel injector”) or pronouns or placeholders (e.g., “the thing”), a longer or shorter synonym (e.g., “the medication” versus. “the pills”), or jargon terms associated with a higher or lower comprehension or familiarity levels with the candidate term, the NLP system can adjust the supplementation level of the reader accordingly. For example, when a first speaker refers to a drug alternatively as naproxen sodium, naproxen, and an “N-said” (for non-steroidal anti-inflammatory drug (NSAID)), and a second speaker refers to that same drug as “my arthritis pills” or various brand names for the drug, the NLP system may assign a supplementation level to the first speaker that reflects greater familiarity (and less interest) in the associated candidate terms and a supplementation level to the second speaker that reflects lesser familiarity (and more interest) in the associated candidate terms. Accordingly, the NLP system may not identify naproxen sodium, naproxen, and other related terms as candidate terms for the first speaker when a reader, but may identify those same terms as candidate terms for the second speaker when a reader.

Additionally or alternatively to analyzing the vocabulary choices used by the reader as a speaker, the NLP system may analyze the sentence structure of the utterances to identify speech patterns indicative of varying levels of interest or competence in various subjects. For example, the NLP system may assign a less-interested supplementation level to speakers with shorter sentences than to speakers with longer sentences. In another example, the NLP system may assess each speaker according to a Flesch-Kincaid score to identify speakers with more-expert speaking styles (and thus higher scores) who are likely more familiar with the basic concepts compared to speakers with lower scores.

At sub-block 538, the NLP system identifies non-adept usage of various terms by the speakers. In various embodiments, the NLP identifies non-adept usage based on difficulties in pronouncing various terms, such as when the transcript version of the term was identified with a low confidence score (e.g., a confidence score for the “best” transcribed term being below a threshold confidence), the rate of speech when uttering the term falls outside of a threshold range of the average rate of speech for the speaker, a user submits a manual correction for the term in the transcript, or the like.

At block 540, the analysis system or layer of the NLP system identifies candidate terms from the transcript based on the supplementation level for the reader (e.g., identified per block 530). In various embodiments, various terms may be identified as potential candidate terms from a dictionary or other list of terms, and the NLP system uses the identified supplementation level to identify terms that appear in the transcript that match to the supplementation level.

For example, the terms “carburetor”, “catalytic converter”, and “crankshaft” may all be present in a dictionary of terms that are potential candidate terms, but only the terms “catalytic converter” and “crankshaft appear” in the transcript, while “catalytic converter” and “crankshaft” are associated by the NLP system with a first supplementation level and “carburetor” and “catalytic converter” are associated with a second supplementation level. Accordingly, for a reader identified with the first supplementation level, the NLP system identifies “catalytic converter” and “crankshaft” as candidate terms, while the NLP system would identify only “catalytic converter” as a candidate term (noting that “carburetor” is absent from the transcript) for a reader identified with the second supplementation level.

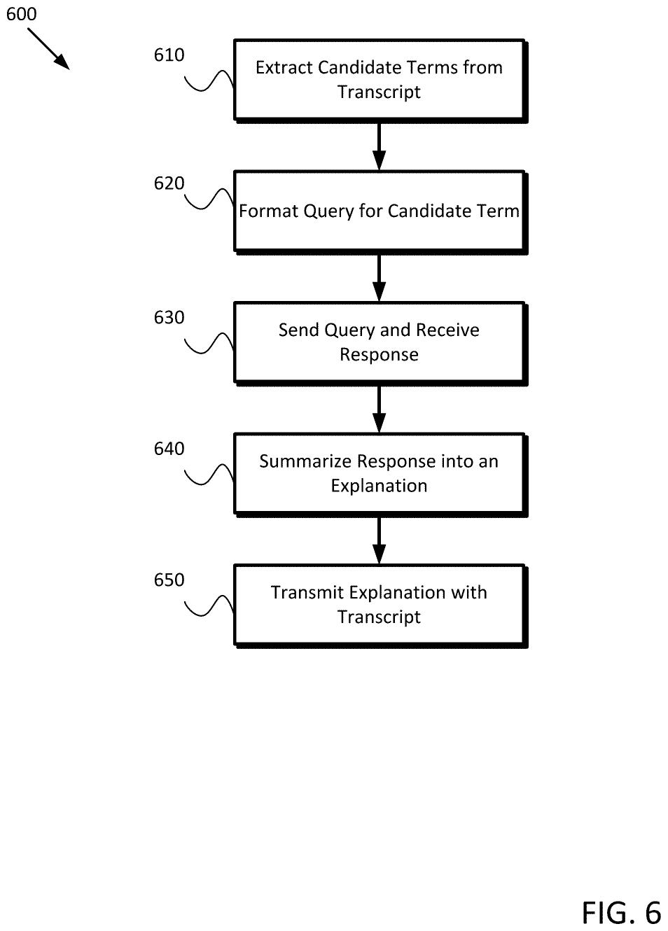

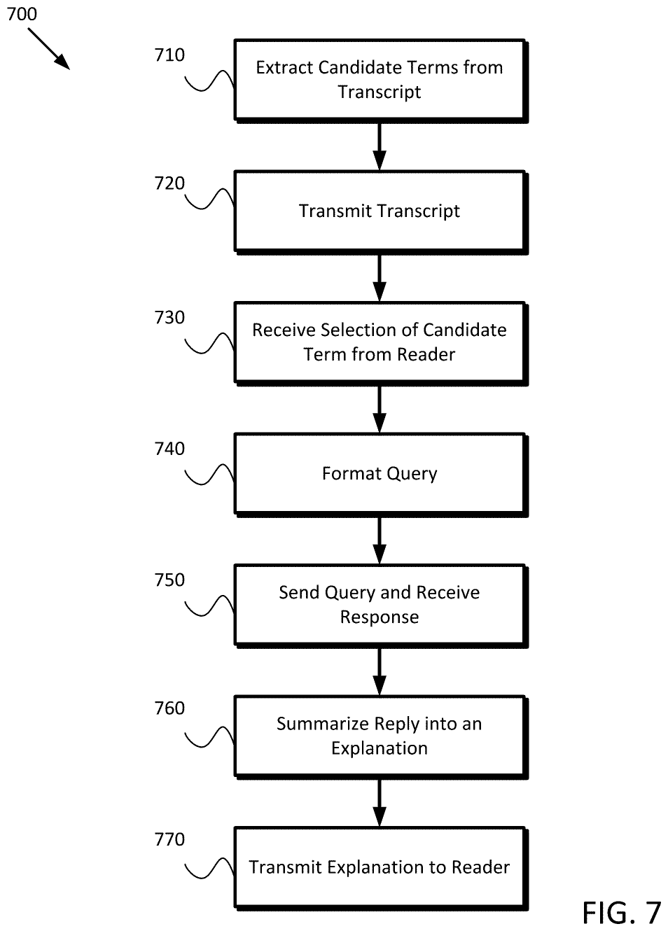

In various embodiments, the candidate terms identified from the transcript can be divided into two sets, where a first set is prepopulated for provision to the reader along with the transcript (e.g., according to method 600 in regard to FIG. 6) and a second set is identified, but left un-provided until a reader selects an indicator in the UI to receive the explanation therefor (e.g., according to method 700 discussed in relation to FIG. 7). In some embodiments, one of the first set or the second set of candidate terms may include all of the candidate terms identified per block 540. Accordingly, when the NLP system initially provides the transcript to the reader, all, none, or some other portion of the candidate terms can have associated explanations provided to the reader at the same time. By providing explanations to the reader with the transcript, the NLP system provides for faster presentation of supplemental data to the reader. However, as the reader may not request supplemental information for every candidate term, any pre-provided explanation may represent wasted computing cycles and bandwidth to generate and transmit an unused explanation.

Therefore, the first set may represent the N most often selected candidate terms, candidate terms for which explanations have previously been generated (and stored in a storage database (390)), the N highest rated candidate terms for supplementation level for the reader, the candidate terms that have explanations automatically (e.g., without user selection of a corresponding indicator) presented when displaying the transcript, up to N bytes of explanations to transmit with the transcript, and other threshold criteria to balance which and how many explanations to provide with the transcript versus which and how many explanations to wait to generate or provide in response to a user request.

Method 500 may conclude after block 540, or may repeat to identify a different set of candidate terms for readers of different supplementation levels. One or both of method 600 and method 700 (discussed in relation to FIGS. 6 and 7, respectively) may use the resulting candidate terms from a single performance or multiple performances of method 500.

FIG. 6 is a flowchart of a method 600 for providing supplemental information via a UI to a reader in conjunction with a transcript, according to embodiments of the present disclosure. Method 600 begins at block 610, where the NLP system extracts candidate terms from a transcript, such as, for example, via method 500 discussed in relation to FIG. 5.

At block 620, the NLP system formats a query for the candidate term. In various embodiments, the query is addressed to one or more supplemental data source according to the format specified by the individual data sources. For example, when using an online encyclopedia as a supplemental data source, the query may be formatted as a search query with one or more synonyms for the candidate term. In another example, when using a search engine as a supplemental data source, the query may be formatted as a prompt-line query, which may specify various sites to include or exclude from the potential results. In another example, when using a database as a supplemental data source, the query may be formatted according to a SQL or other database format.

At block 630, the NLP system sends the query to the one or more supplemental data sources and receives the responses from those supplemental data sources. In various embodiments, the responses queries may provide previously generated explanations (e.g., from a storage database 390), raw data that are to be formatted or inserted into a human readable explanation by the NLP system (e.g., from a database), hyperlinks to external sources, or explanations generated by entities other than the NLP system (e.g., articles by other authors).

At block 640, the NLP system summarizes the one or more responses into an explanation for provision to the reader. As used herein, summarizing a response refers to the process used to synthesize an explanation from the transcript and responses using the NLP system that was used to generate the summary of the transcript. By using the same NLP system that generated the summary of the transcript to also generate the explanations for candidate terms in the transcript, the NLP system provides composite human-readable explanations, which combine certain vocabulary and grammatical elements of a base conversation with the supplemental content received as responses from supplemental data sources. Accordingly, the reader is provided with an improved experience, with easier to read explanations, an easier mapping between related concepts in the explanation and the transcript, presents a unified style with the transcript even when drawing supplemental data from sources external to the conversation, maintains the impression (to the reader) that the reader is viewing content generated by the NLP system, and keeps the reader within the UI environment provided in conjunction with the NLP system rather than sending the reader to external parties to research the candidate term on their own, among other benefits.

For example, the NLP system can use a response that includes data taken from a source webpage and reformat the response to produce the explanation using the summarization process applied to the transcript. The NLP system can format the data according to the supplementation level of the reader to discard or ignore portions of the original data that are not expected to be of interest to the reader or not provide explanatory information related to the candidate term. The content identified as relevant (e.g., the data not discarded or ignored) is then arranged into a human-readable format according to the goals of sufficiency, minimality, and naturalness.

The NLP system can identify terms with synonyms in the response matching terms in the transcript and substitute those in the transcript for those in the response when generating the explanation. For example, when the response includes data related to diphenhydramine, but the conversation refers to diphenhydramine by a popular brand name, the NLP system can replace some or all of the instances of “diphenhydramine” in the explanation with the brand name used in the conversation. In another example, when the response includes information related the candidate term as a pronoun or other placeholder, the NLP may substitute the candidate term for the pronoun or placeholder.

At block 650, the NLP system transmits the explanation for the key term summarized per block 640 to the reader along with the transcript. In various embodiments, the NLP system may transmit one or several explanations for a corresponding number of key terms along with the transcript. In various embodiments, the NLP system may transmit the explanation(s) and the transcript to a user device associated with the reader or to a cloud or other external repository for access by the reader. Method 600 may then conclude.

FIG. 7 is a flowchart of a method 700 for providing supplemental information via a UI to a reader in conjunction with a transcript, according to embodiments of the present disclosure. Method 700 begins at block 710, where the NLP system extracts candidate terms from a transcript, such as, for example, via method 500 discussed in relation to FIG. 5.

At block 720, the NLP system transmits the transcript to the reader. In various embodiments, the transmission can include one or more explanations generated per method 600 (discussed in relation to FIG. 6).

At block 730, the NLP system receives a selection of a candidate term from the reader for which an explanation was not yet provided (e.g., by an earlier instance of method 700 or with the transcript per method 600 discussed in relation to FIG. 6). In various embodiments, the selection can be made by the reader manually selecting an indicator in a UI associated with the candidate term or the reader supplying a selection of a term not identified by the NLP system as a candidate term (e.g., selecting a term in the transcript and requesting an explanation, using a voice command to request an explanation, etc.).

At block 740, the NLP system formats a query for the candidate term. In various embodiments, the query is addressed to one or more supplemental data source according to the format specified by the individual data sources. For example, when using an online encyclopedia as a supplemental data source, the query may be formatted as a search query with one or more synonyms for the candidate term. In another example, when using a search engine as a supplemental data source, the query may be formatted as a prompt-line query, which may specify various sites to include or exclude from the potential results. In another example, when using a database as a supplemental data source, the query may be formatted according to an SQL or other database format.

At block 750, the NLP system sends the query to the one or more supplemental data sources and receives the responses from those supplemental data sources. In various embodiments, the responses queries may provide previously generated explanations (e.g., from a storage database 390), raw data that are to be formatted or inserted into a human readable explanation by the NLP system (e.g., from a database), hyperlinks to external sources, or explanations generated by entities other than the NLP system (e.g., articles by other authors).

At block 760, the NLP system summarizes the one or more responses into an explanation for provision to the reader. As used herein, summarizing a response refers to the process used to synthesize an explanation from the transcript and responses using the NLP system that was used to generate the summary of the transcript. By using the same NLP system that generated the summary of the transcript to also generate the explanations for candidate terms in the transcript, the NLP system provides composite human-readable explanations, which combine certain vocabulary and grammatical elements of a base conversation with the supplemental content received as responses from supplemental data sources. Accordingly, the reader is provided with an improved experience, with easier to read explanations, an easier mapping between related concepts in the explanation and the transcript, presents a unified style with the transcript even when drawing supplemental data from sources external to the conversation, maintains the impression (to the reader) that the reader is viewing content generated by the NLP system, and keeps the reader within the UI environment provided in conjunction with the NLP system rather than sending the reader to external parties to research the candidate term on their own, among other benefits.

For example, the NLP system can use a response that includes data taken from a source webpage and reformat the response to produce the explanation using the summarization process applied to the transcript. The NLP system can format the data according to the supplementation level of the reader to discard or ignore portions of the original data that are not expected to be of interest to the reader or not provide explanatory information related to the candidate term. The content identified as relevant (e.g., the data not discarded or ignored) is then arranged into a human-readable format according to the goals of sufficiency, minimality, and naturalness.

The NLP system can identify terms with synonyms in the response matching terms in the transcript and substitute those in the transcript for those in the response when generating the explanation. For example, when the response includes data related to diphenhydramine, but the conversation refers to diphenhydramine by a popular brand name, the NLP system can replace some or all of the instances of “diphenhydramine” in the explanation with the brand name used in the conversation. In another example, when the response includes information related the candidate term as a pronoun or other placeholder, the NLP may substitute the candidate term for the pronoun or placeholder.

At block 770, the NLP system transmits the explanation for the key term summarized per block 760 to the reader. In various embodiments, the NLP system may transmit the explanation to a user device associated with the reader or to a cloud or other external repository for access by the reader. Method 700 may then conclude, but additional instances of method 700 may be performed starting a block 730 when using the same initial transcript to provide additional explanations for other candidate terms selected by the reader that were not initially provided with the transcript (e.g., as per method 600 discussed in relation to FIG. 6).

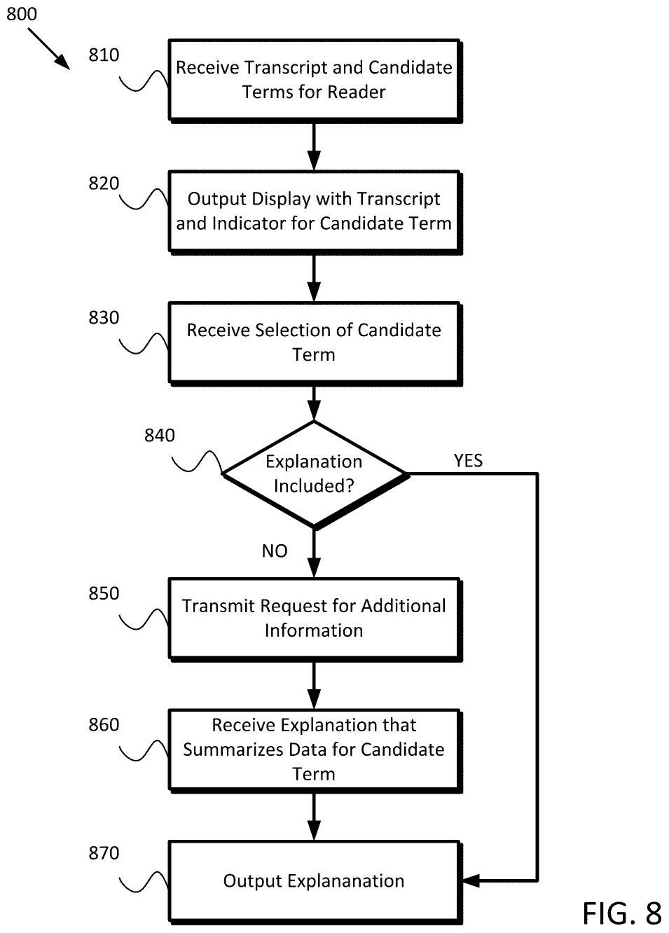

FIG. 8 is a flowchart of a method 800 for managing a GUI to provide explanations of candidate terms in association with a transcript, according to embodiments of the present disclosure. Method 800 begins at block 810, where a reader device receives a transcript and candidate terms for provision to the reader. In various embodiments, the reader device can receive some, all, or none of the explanations associated with the candidate terms when the transcript is received.

At block 820, the reader device outputs a display in a GUI that includes the transcript and one or more indicators for candidate terms at positions, which may include indicators positioned with a summary or action item developed from the transcript. In various embodiments, the indicators may provide GUI elements that the reader may select to request the display of an associated explanation for the candidate term. Indicators are provided in the GUI at various locations that indicate where the associated explanation will be displayed, and may allow for dismissal of the explanation on re-selection by the reader.

In various embodiments, some of all the candidate terms can be provided with (e.g., per method 600 discussed in relation to FIG. 6) or without (e.g., per method 700 discussed in relation to FIG. 7) associated explanations at the time the transcript is received by the reader device, and are provided with indicators that may indicate the status of the explanation (e.g., pre-populated or not) or provide similar indicators for candidate terms with locally stored or not-yet-received explanations.

At block 830, the reader device receives selection of a candidate term from the reader. The reader may submit the selection via a touch screen, mouse, keyboard command, or other GUI interaction command, or via voice command. In various embodiments, the reader may select the candidate term via an associated indicator in the GUI or direct selection of a term in the transcript or summary. In various embodiments, a reader may identify one or more terms in the transcript that the reader considers to be candidate terms for which supplemental explanation is desired, but the NLP system did not identify as such. For example, a reader may highlight a term in the transcript to request additional information about the term when an indicator is not initially provided in association with that term.

At block 840, the reader device determines whether the explanation for the selected candidate term from block 830 is included with the transcript. When the explanation is included, method 800 proceeds to block 870. Otherwise, when the explanation is not included, method 800 proceeds to block 850.

At block 850, when the explanation was not transmitted to the reader device along with the transcript, the reader device transmits a request to the NLP system to return an explanation for the candidate term selected in block 830. In various embodiments, the request includes the candidate term for which the explanation is sought and an indication of whether the candidate term is user-selected or was previously identified by the NLP system as a candidate term, but for which the explanation was not initially provided. In various embodiments, by transmitting a request with the selected candidate term (whether NLP-identified or reader-identified) to the NLP system to produce an explanation, the reader device may induce the NLP system to perform blocks 730-770 of method 700 discussed in FIG. 7.

At block 860, the reader device receives the explanation that summarizes supplemental data for the candidate term. In various embodiments, the reader device (or cloud based solution that the reader device draws from) may save the received explanation in association with the transcript for later lookup and presentation as if the explanation were initially provided to the reader with the transcript. For example, when the data for the explanation are formatted in an XML or other delineated schema, the reader device (or storage device acting on behalf of the reader device) may append the explanation to the file storing the transcript.

At block 870, the reader device outputs the explanation in the GUI. In various embodiments, the GUI can display the explanation in association with the candidate term for which the explanation is provided, and may position an informational window that includes the explanation and one or more controls (e.g., action controls, feedback controls) so that the candidate term in the transcript or summary remains readable, but may overlay or shift other elements in the GUI to position the informational window relative to the candidate term. Stated differently, to maintain the legibility of the section of the transcript or summary from which the reader selected the candidate term and the legibility of the informational window, the reader device may adjust the layout of the elements in the GUI. In various embodiments, when the candidate term is a user-selected candidate term (e.g., a term not initially identified by the NLP system as a candidate term for the reader), the reader device also generates and displays one or more indicators in association with the candidate term in the GUI, which may also affect the layout of the summary or the transcript. In various embodiments, the information window may be modal or non-modal, and the GUI may permit the concurrent display of multiple information windows for different candidate terms or permit the display of a single information window at a time.

In various embodiments, the informational window may be output with various action controls or other behaviors to dismiss the informational window or present a new explanation in the information window (e.g., by a reader selecting the candidate term a second time, issuing a voice/keyboard/pointer command, or selecting a different candidate term). In some embodiments, such as when the informational window is automatically displayed by the reader device when playing back audio of the conversation, the reader device may automatically display the informational window and explanation for a set amount of time before playing back the audio associated with the candidate term and leave the informational window displayed for a set amount of time after playing back the audio associated with the candidate term, until a new explanation is to be provided, or user input is received to dismiss the informational window.

Method 800 may then conclude.

FIG. 9 illustrates physical components of an example computing device 900 according to embodiments of the present disclosure. The computing device 900 may include at least one processor 910, a memory 920, and a communication interface 930.

The processor 910 may be any processing unit capable of performing the operations and procedures described in the present disclosure. In various embodiments, the processor 910 can represent a single processor, multiple processors, a processor with multiple cores, and combinations thereof.

The memory 920 is an apparatus that may be either volatile or non-volatile memory and may include RAM, flash, cache, disk drives, and other computer readable memory storage devices. Although shown as a single entity, the memory 920 may be divided into different memory storage elements such as RAM and one or more hard disk drives. As used herein, the memory 920 is an example of a device that includes computer-readable storage media, and is not to be interpreted as transmission media or signals per se.

As shown, the memory 920 includes various instructions that are executable by the processor 910 to provide an operating system 922 to manage various features of the computing device 900 and one or more programs 924 to provide various functionalities to users of the computing device 900, which include one or more of the features and functionalities described in the present disclosure. One of ordinary skill in the relevant art will recognize that different approaches can be taken in selecting or designing a program 924 to perform the operations described herein, including choice of programming language, the operating system 922 used by the computing device, and the architecture of the processor 910 and memory 920. Accordingly, the person of ordinary skill in the relevant art will be able to select or design an appropriate program 924 based on the details provided in the present disclosure.

Additionally, the memory 920 can include one or more of machine learning models 926 for speech recognition and analysis, as described in the present disclosure. As used herein, the machine learning models 926 may include various algorithms used to provide “artificial intelligence” to the computing device 900, which may include Artificial Neural Networks, decision trees, support vector machines, genetic algorithms, Bayesian networks, or the like. The models may include publically available services (e.g., via an Application Program Interface with the provider) as well as purpose-trained or proprietary services. One of ordinary skill in the relevant art will recognize that different domains may benefit from the use of different machine learning models 926, which may be continuously or periodically trained based on received feedback. Accordingly, the person of ordinary skill in the relevant art will be able to select or design an appropriate machine learning model 926 based on the details provided in the present disclosure.

The communication interface 930 facilitates communications between the computing device 900 and other devices, which may also be computing devices 900 as described in relation to FIG. 9. In various embodiments, the communication interface 930 includes antennas for wireless communications and various wired communication ports. The computing device 900 may also include or be in communication, via the communication interface 930, one or more input devices (e.g., a keyboard, mouse, pen, touch input device, etc.) and one or more output devices (e.g., a display, speakers, a printer, etc.).

Accordingly, the computing device 900 is an example of a system that includes a processor 910 and a memory 920 that includes instructions that (when executed by the processor 910) perform various embodiments of the present disclosure. Similarly, the memory 920 is an apparatus that includes instructions that when executed by a processor 910 perform various embodiments of the present disclosure.

Programming modules, may include routines, programs, components, data structures, and other types of structures that may perform particular tasks or that may implement particular abstract data types. Moreover, embodiments may be practiced with other computer system configurations, including hand-held devices, multiprocessor systems, microprocessor-based or programmable user electronics, minicomputers, mainframe computers, and the like. Embodiments may also be practiced in distributed computing environments where tasks are performed by remote processing devices that are linked through a communications network. In a distributed computing environment, programming modules may be located in both local and remote memory storage devices.

Furthermore, embodiments may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SoC)). Embodiments may also be practiced using other technologies capable of performing logical operations such as, for example, AND, OR, and NOT, including, but not limited to, mechanical, optical, fluidic, and quantum technologies. In addition, embodiments may be practiced within a general purpose computer or in any other circuits or systems.

Embodiments may be implemented as a computer process (method), a computing system, or as an article of manufacture, such as a computer program product or computer-readable storage medium. The computer program product may be a computer-readable storage medium readable by a computer system and encoding a computer program of instructions for executing a computer process. Accordingly, hardware or software (including firmware, resident software, micro-code, etc.) may provide embodiments discussed herein. Embodiments may take the form of a computer program product on a computer-usable or computer-readable storage medium having computer-usable or computer-readable program code embodied in the medium for use by, or in connection with, an instruction execution system.

Although embodiments have been described as being associated with data stored in memory and other storage mediums, data can also be stored on or read from other types of computer-readable media, such as secondary storage devices, like hard disks, floppy disks, or a CD-ROM, or other forms of RAM or ROM. The term computer-readable storage medium refers only to devices and articles of manufacture that store data or computer-executable instructions readable by a computing device. The term computer-readable storage medium does not include computer-readable transmission media.

Embodiments described in the present disclosure may be used in various distributed computing environments where tasks are performed by remote processing devices that are linked through a communications network.

Embodiments described in the present disclosure may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented with computing device 900 or any other computing devices, in combination with computing device 900, wherein functionality may be brought together over a network in a distributed computing environment, for example, an intranet or the Internet, to perform the functions as described herein. The systems, devices, and processors described herein are provided as examples; however, other systems, devices, and processors may comprise the aforementioned memory storage and processing unit, consistent with the described embodiments.

The descriptions and illustrations of one or more embodiments provided in this application are intended to provide a thorough and complete disclosure of the full scope of the subject matter to those of ordinary skill in the relevant art and are not intended to limit or restrict the scope of the subject matter as claimed in any way. The embodiments, examples, and details provided in this disclosure are considered sufficient to convey possession and enable those of ordinary skill in the relevant art to practice the best mode of the claimed subject matter. Descriptions of structures, resources, operations, and acts considered well-known to those of ordinary skill in the relevant art may be brief or omitted to avoid obscuring lesser known or unique aspects of the subject matter of this disclosure. The claimed subject matter should not be construed as being limited to any embodiment, aspect, example, or detail provided in this disclosure unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently.

Having been provided with the description and illustration of the present disclosure, one of ordinary skill in the relevant art may envision variations, modifications, and alternative embodiments falling within the spirit of the broader aspects of the general inventive concept provided in this disclosure that do not depart from the broader scope of the present disclosure.

As used in the present disclosure, a phrase referring to “at least one of” a list of items refers to any set of those items, including sets with a single member, and every potential combination thereof. For example, when referencing “at least one of A, B, or C” or “at least one of A, B, and C”, the phrase is intended to cover the sets of: A, B, C, A-B, B-C, and A-B-C, where the sets may include one or multiple instances of a given member (e.g., A-A, A-A-A, A-A-B, A-A-B-B-C-C-C, etc.) and any ordering thereof.

As used in the present disclosure, the term “determining” encompasses a variety of actions that may include calculating, computing, processing, deriving, investigating, looking up (e.g., via a table, database, or other data structure), ascertaining, receiving (e.g., receiving information), accessing (e.g., accessing data in a memory), retrieving, resolving, selecting, choosing, establishing, and the like.

The following claims are not intended to be limited to the embodiments shown herein, but are to be accorded the full scope consistent with the language of the claims. Within the claims, reference to an element in the singular is not intended to mean “one and only one” unless specifically stated as such, but rather as “one or more” or “at least one”. Unless specifically stated otherwise, the term “some” refers to one or more. No claim element is to be construed under the provision of 35 U.S.C. § 112(f) unless the element is expressly recited using the phrase “means for” or “step for”. All structural and functional equivalents to the elements of the various embodiments described in the present disclosure that are known or come later to be known to those of ordinary skill in the relevant art are expressly incorporated herein by reference and are intended to be encompassed by the claims. Moreover, nothing disclosed in the present disclosure is intended to be dedicated to the public regardless of whether such disclosure is explicitly recited in the claims.

We claim:

1. A method, comprising:
analyzing a transcript of a conversation, by a Natural Language Processing (NLP) system, to identify at least one candidate term in the conversation to provide supplemental information for to a reader of the transcript;
in response to receiving, from the reader, a selection of the candidate term, formatting a query that includes the candidate term;
in response to receiving a reply to the query:
summarizing the reply into an explanation in a human-readable format; and
outputting the explanation to the reader.

2. The method of claim 1, wherein the NLP system identifies the candidate term from an action item generated from the transcript.

3. The method of claim 1, wherein the explanation includes a hyperlink to usage of the candidate term in the transcript associated with an utterance received from a party to the conversation.

4. The method of claim 1, wherein contents of the explanation are retrieved from a supplemental data source selected by a party in the conversation, different from the reader.

5. The method of claim 1, wherein the human-readable format is selected from a plurality of human-readable formats by the NLP system based on a supplementation level of the reader, and wherein the explanation uses vocabulary extracted from the transcript.

6. The method of claim 1, further comprising:
in response to receiving, from the reader, the selection of the candidate term, adding the selection to an aggregation report; and
providing the aggregation report to a second party to the conversation, other than the reader.

7. The method of claim 1, wherein the explanation includes a hyperlink to an external source used by the NLP system to generate contents of the explanation.

8. A method, comprising:
transmitting, to a Natural Language Processing (NLP) system, audio from a conversation including utterances from a first party and a second party;
receiving a transcript of the conversation from the NLP system and a candidate term identified from the transcript;
outputting, to the first party, a display of the transcript and an indicator associated with the candidate term;
in response to receiving a selection of the indicator, transmitting a request for additional information on the candidate term;
receiving an explanation that summarizes data related to the candidate term retrieved from a supplemental data source, wherein the explanation is provided in a human-readable format; and
outputting, to the first party, the explanation.

9. The method of claim 8, further comprising:
assessing a supplementation level of the first party using terminology extracted from utterances associated with the first party in a transcript of the conversation;
selecting the human-readable format from a plurality of human-readable formats based on the supplementation level assessed for the first party; and
requesting the explanation from the NLP system according to the human-readable format selected.

10. The method of claim 8, wherein the explanation is received from the NLP system with the transcript.

11. The method of claim 8, wherein the supplemental data source is selected by the second party.

12. The method of claim 8, further comprising:
identifying utterances from the second party related to the candidate term; and
in response to receiving the selection of the indicator, outputting the utterances to the first party.

13. The method of claim 8, wherein the explanation is received with a transcript generated by the NLP system, further comprising:
adjusting display of the transcript in a graphical user interface to show segments of the transcript that the NLP system extracted the candidate term from.

14. The method of claim 8, wherein the indicator is included in an action item assigned to the first party based on the transcript.

15. The method of claim 14, wherein the action item is created by the NLP system using terminology and context from a transcript of the conversation.

16. A method, comprising:
receiving, from a Natural Language Processing (NLP) system, a transcript of a conversation between at least a first party and a second party and a summary of the transcript that includes a candidate term to provide supplemental information for;
generating a first display on a user interface that includes the transcript, the summary, and an indicator for the candidate term;
in response to receiving a selection of the indicator from a reader:
generating an informational window in the user interface that includes an explanation related to the candidate term; and
adjusting display of the user interface to highlight a section of the transcript from which the NLP system identified the candidate term as part of an key point from the conversation, wherein the informational window is positioned with the section to maintain legibility of the section and the informational window.

17. The method of claim 16, further comprising:
providing audio playback of the section to the reader.

18. The method of claim 16, wherein the reader is the first party and the summary is tuned to a supplementation level of the first party that is based on vocabulary extracted from the transcript.

19. The method of claim 16, wherein the key point is generated by the NLP system using terminology and context from the transcript.

20. The method of claim 16, further comprising:
populating the informational window with supplemental data from an external supplemental data source identified by the second party, different than the reader, that is under control of a third party, different from the second party and the reader.
